(19) United States
(12) Patent Application Publication
(10) Pub. No.: US 2026/0356706 A1
(43) Pub. Date: Nov. 12, 2026

(54) ELECTRO-FLUIDIC DEVICES WITH VERTICALLY STACKED IONIC TRANSPORT STRUCTURES

(71) Applicant: Mohammad Najmzadeh, San Jose, CA (US)

(72) Inventor: Mohammad Najmzadeh, San Jose, CA (US)

(21) Appl. No.: 19/670,416

(22) Filed: May 7, 2026

Related U.S. Application Data
(60) Provisional application No. 63/802,379, filed on May 8, 2025.

(51) Int. Cl. C02F 1/469; C02F 1/42

(52) U.S. Cl. CPC C02F 1/4695; C02F 1/42; C02F 2201/46115

(57) ABSTRACT

Electro-fluidic desalination devices employing vertically stacked ionic transport structures include an electrochemical apparatus having a vertical stack with at least one ion exchange membrane positioned in substantially parallel alignment between at least two electrodes. The vertical stack is configured with at least two electrical connections to enable ion transport across the ion-exchange membrane. The electrochemical apparatus may be configured for desalination processes including electrodialysis (ED), electrodeionization (EDI), ion concentration polarization (ICP), reverse electrodialysis (RED), and reverse electrodeionization (REDI), and may also operate in concentration-gradient energy recovery modes. Methods of manufacturing and operating the electrochemical apparatus are provided. A full-system electro-fluidic water desalination platform including vertical stack devices and energy-recovery subsystems may operate at energy consumption approaching or below historically recognized thermodynamic limits for sea water desalination. Such architectures may enable highly energy-efficient desalination and scalable electrochemical platform systems.

### CROSS REFERENCE TO RELATED APPLICATION

This application claims benefit of U.S. Provisional Application Ser. No. 63/802,379 entitled, “Dense Vertical Stack Architectures for Enhanced Nanoscale Ionic Transport” filed May 8, 2025, the entire disclosure of which is incorporated herein by reference.

### FIELD OF THE DISCLOSURE

The present disclosure relates to electro-fluidic devices employing vertically stacked ionic transport structures. In particular, the disclosure relates to devices configured for electrodialysis (ED), electrodeionization (EDI), ion concentration polarization (ICP), gated ionic transport, reverse electrodialysis (RED) and reverse electrodeionization (REDI), using dense vertical electrochemical stack architectures.

### BACKGROUND OF THE DISCLOSURE

Traditional methods to desalinate sea water and other water having a salinity content include either reverse-osmosis or thermal evaporation. Reverse-osmosis pushes water via membranes with ultra-narrow pore size that should pass only water molecules and block ions and particles. It requires a high-pressure pump to overcome the osmotic pressure. It also requires regular membrane replacement. Therefore, it consumes high energy and has a high cost, in particular, a high maintenance cost due to the frequent changing of the membrane. Thermal evaporation also consumes high energy and its cost highly depends on the fuel price for generating heat. Thermal evaporation methods also have scalability limitations, in that, they typically require plant-sized factories and are not generally suitable for smaller applications.

Several electric desalination methods are known in the art, including electrodialysis (ED), electrodeionization (EDI), capacitive deionization (CDI), and ion concentration polarization (ICP). These electric desalination methods potentially address many of the shortcomings related to reverse-osmosis desalination, since they are based on ion migration using electric field and they do not require high-pressure pump or regular membrane replacement. They typically are employed to desalinate low concentrate feed water such as brackish water, e.g., typically containing approximately 0.5-30 g/L of salt. But they show inefficiency for higher salt concentration such as sea water, which typically has 33-37 g/L concentration of salt. Additionally, conventional electric desalination systems are commonly large and they can have high manufacturing costs. For example, the conventional stack of ion exchange membranes and the full desalination components require mechanical assembly, which consumes materials and cost.

FIG. 1 is a diagrammatical illustration of an electrodialysis system for desalination, as an example of a traditional electrochemical system, in accordance with the prior art. Specifically, FIG. 1 shows an array or stack 10 of an electrodialyzer, where the stack 10 is a sheet flow type with a large footprint generally formed from membranes and gaskets in various alternating positions. The stack 10 includes a desalting cell 12, a concentrating cell 14, a duct 16, individual ion exchange membranes, including a cation exchange membrane (CEM) 18 and an anion exchange membrane (AEM) 20, electrodes and electrode compartments 22, gaskets 24, spacers 26, slots 28, a fastening frame 30, solution feeding frame 32, a feeding solution 34, a desalted solution 36, a concentrated solution 38, and an oil pressure press to adjust the pressure. Traditional ion exchange membranes (IEM), such as CEM 18, and AEM 20 are manufactured in the forms of dense polymer sheets using solvent casting, extrusion or other methods, with a typical sub-200 μm thickness. The gaskets 24 include rubber or the other flexible materials to provide peripheral sealing between membranes 18, 20. The spacers 26, often composed of polymer mesh or netting, are placed within the gasket region to define the internal flow path and maintain separation between membranes 18, 20. The typical thickness of the gasket and spacer may be around 0.5-2 mm. With a pair of an IEM membrane, e.g., one CEM 18 and one AEM 20, and one gasket 24 and/or spacer 26 as either a dilute or desalinating cell 12 or a concentrate brine cell 14, the total cell thickness may be a few mm. It is noted that such a large system dimension may result in a significant amount of electric resistance between the two electrode compartments 22 and therefore, a large amount of energy may be consumed to perform ion transport in a traditional ED system to be able to produce a separate dilute flow and a separate concentrate brine flow.

Although ED is used here as a representative example of an electrochemical desalination system, similar limitations in ionic transport efficiency may arise in other electrochemical systems that rely on separated ion exchange membrane compartments and fluidic transport paths. For desalination applications, such systems may include, but are not limited to, ion concentration polarization (ICP), electrodeionization (EDI), and concentration-gradient-based energy recovery devices such as reverse electrodialysis (RED). In many such systems, the thickness of functional components including gaskets, spacers, ion-exchange membranes (IEMs), and electrodes determines the ionic transport distance, which can significantly influence electrical resistance, energy consumption, and system scalability.

### SUMMARY OF THE DISCLOSURE

Embodiments of the present disclosure provide an electrochemical apparatus. Briefly described, in architecture, one embodiment of the apparatus, among others, can be implemented as follows. The electrochemical apparatus has a vertical stack formed from at least one ion exchange membrane in substantially parallel alignment, and at least two electrodes, wherein the at least one ion exchange membrane is positioned between the at least two electrodes. At least two electrical connections are formed for the vertical stack.

In certain embodiments, the electrochemical apparatus may be configured for desalination such as electrodialysis (ED), ion concentration polarization (ICP), electrodeionization (EDI), concentration gradient-based energy recovery such as reverse electrodialysis (RED). Additional components such as gaskets, spacers, fluidic connectors, bipolar ion exchange membranes, bipolar plates, vertical fluidic channels, may be included depending on the application specific fluidic, electrical or chemical design requirements.

In additional embodiments, the electrochemical apparatus may be configured for various applications like fuel cell operation, hydrogen generation and electrolysis, acid/base generation, or solid-state rechargeable battery. For a full-system operation of an electrochemical platform, such as water desalination, one or more electrochemical apparatuses might get configured to operate in series, parallel or the other configurations. Such a full-system may include electrochemical apparatuses configured for desalination, acid/base generation, chlorine generation, fuel cell, concentration gradient-based energy recovery, solid-state rechargeable battery purposes. Additionally, the full-system may incorporate non-electrochemical based modules, to e.g. recycle the electrode rinse solutions of the electrochemical apparatuses and optionally harvest hydrogen and oxygen for energy generation. Specifically, for sea water desalination, such a full system with energy recovery subsystems, might achieve an overall energy consumption substantially below 1.1 kWh/m³ (which was historically known as the thermodynamic limit for sea water desalination in the desalination component level without energy recovery subsystems), such as ~0.82 kWh/m³, at desalination stage recovery ratio of 50%.

The present disclosure can also be viewed as providing methods of manufacturing and operating electrochemical apparatuses. In this regard, one embodiment of such a method, among others, can be broadly summarized by the following steps: forming a vertical stack by: positioning at least one ion exchange membrane in substantially parallel alignment; and positioning the at least one ion exchange membrane between the at least two electrodes.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagrammatical illustration of an electrodialysis system for desalination, as an example of a traditional electrochemical system, in accordance with the prior art.

FIG. 2A is a diagrammatical illustration of an electrochemical apparatus configured for electric desalination ED, in accordance with the present disclosure.

FIG. 2B is a diagrammatical illustration of an electrochemical apparatus configured for electric desalination ED, showing uniform fluidic compartment gaps of 500 μm (left) and 5 μm (right), as examples of dimensions for downscaling of compartment gaps, in accordance with the present disclosure.

FIG. 2C is a graphical illustration of an electrochemical apparatus in desalination ED mode, as shown in FIG. 2B, presenting a qualitative plot that illustrates the relative contribution of various energy consumption mechanisms associated with uniform fluidic compartment gap reduction, in accordance with the present disclosure.

FIG. 3 is a diagrammatical illustration of the construction of a vertical stack for forming an electrochemical apparatus, such as electric desalination ED, using nanofabrication methods, in accordance with the present disclosure.

FIG. 4 is a top-view illustration of a process for forming gaskets for use in an electrochemical apparatus, such as for electric desalination ED, in accordance with the present disclosure.

FIGS. 5A-5D are top-view illustrations of example gasket configurations for use in an electrochemical apparatus, such as for electric desalination ED, in accordance with the present disclosure.

FIGS. 6A-6B are illustrations of a process for forming spacers for use in an electrochemical apparatus, such as for electric desalination ED, in accordance with the present disclosure.

FIG. 7A is an operational schematic illustration of an electrochemical apparatus, in electric desalination ED mode using IEMs with fixed surface charges, in accordance with the present disclosure.

FIG. 7B is an operational schematic illustration of an electrochemical apparatus, in electric desalination ED mode using gated-IEMs with tunable surface charges, in accordance with the present disclosure.

FIG. 7C is an operational schematic illustration of an electrochemical apparatus, in electric desalination ED mode, as shown in FIG. 7A, illustrating fluidic and electric contacts on the top-side of the electrochemical chip, in accordance with the present disclosure.

FIG. 8A is an operational schematic illustration of an electrochemical apparatus, in electric desalination ICP mode using IEMs with fixed surface charges, in accordance with the present disclosure.

FIG. 8B is an operational schematic illustration of an electrochemical apparatus, in electric desalination ICP mode, as shown in FIG. 8A, illustrating ion transport, in accordance with the present disclosure.

FIG. 8C is an operational schematic illustration of an electrochemical apparatus, in electric desalination ICP mode using gated-IEMs with fixed surface charges, in accordance with the present disclosure.

FIG. 9A is a diagrammatical illustration of the construction of a vertical stack for forming an electrochemical apparatus, such as electric desalination, using combined modular assembly and/or nanofabrication methods, in accordance with the present disclosure.

FIG. 9B is an operational schematic illustration of an electrochemical apparatus, in electric desalination mode, constructed as shown in FIG. 9A, illustrating fluidic and electric contacts on both sides of the electrochemical chip, in accordance with the present disclosure.

FIG. 9C is an operational schematic illustration of an electrochemical apparatus, in electric desalination ED mode using IEMs with fixed surface charges, and constructed through combined modular assembly and/or nanofabrication, in accordance with the present disclosure.

FIG. 9D is an operational schematic illustration of an electrochemical apparatus, in electric desalination ICP mode using IEMs with fixed surface charges, and constructed through combined modular assembly and/or nanofabrication, in accordance with the present disclosure.

FIG. 10A is a diagrammatical illustration of an electrochemical apparatus configured for electric desalination ED, showing a reduction in concentrate brine compartment gap from 160 μm (left) to 20 μm (right), as numeric value examples, while maintaining a fixed dilute compartment gap of 160 μm on both sides, in accordance with the present disclosure.

FIG. 10B is a graphical illustration of an electrochemical apparatus in desalination ED mode, as shown in FIG. 10A, presenting recovery ratio as a function of concentrate brine compartment gap reduction, at a fixed dilute compartment gap of e.g. 160 μm, in accordance with the present disclosure.

FIG. 10C is a graphical illustration of an electrochemical apparatus in desalination ED mode, as shown in FIG. 10A, presenting Specific Energy Consumption (SEC) and SEC to recovery ratio (SEC/RR) as functions of recovery ratio (RR), in accordance with the present disclosure.

FIG. 11 is an operational schematic illustration of an electrochemical apparatus, in a multi-stage electric desalination mode configured in series, illustrating fluidic and electric connections, in accordance with the present disclosure.

FIG. 12A is an operational schematic illustration of an electrochemical apparatus, in an energy recovery mode, utilizing a concentration gradient between a feed water stream and a concentrate brine stream from the prior desalination stages to generate electricity, and illustrating fluidic and electric connections, in accordance with the present disclosure.

FIG. 12B is an operational schematic illustration of an electrochemical apparatus, in an energy recovery mode based on concentration gradient, as shown in FIG. 12A, illustrating ion transport, in accordance with the present disclosure.

FIG. 12C is an operational schematic illustration of an electrochemical apparatus, in an energy recovery mode based on concentration gradient, as shown in FIG. 12A, illustrating a multi-stage operation configured in series, in accordance with the present disclosure.

FIG. 13A is an operational schematic illustration of an electrochemical apparatus, in a fuel cell mode using PEMs with fixed surface charges, and constructed through combined modular assembly and/or nanofabrication, in accordance with the present disclosure.

FIG. 13B is an operational schematic illustration of an electrochemical apparatus, in a fuel cell mode using PEMs with fixed surface charges, as shown in FIG. 13A, illustrating ion transport, in accordance with the present disclosure.

FIG. 13C is an operational schematic illustration of an electrochemical apparatus, in a fuel cell mode using gated-PEMs, illustrating fluidic and electric connections, in accordance with the present disclosure.

FIG. 13D is an operational schematic illustration of an electrochemical apparatus, in a fuel cell mode using PEMs with fixed surface charges, illustrating fluidic and electric connections, and constructed through combined modular assembly and/or nanofabrication in accordance with the present disclosure.

FIG. 14A is an operational schematic illustration of an electrochemical apparatus, in a hydrogen generation and electrolysis mode using PEMs with fixed surface charges, and constructed through combined modular assembly and/or nanofabrication, in accordance with the present disclosure.

FIG. 14B is an operational schematic illustration of an electrochemical apparatus, in a hydrogen generation and electrolysis mode using PEMs with fixed surface charges, as shown in FIG. 14A, illustrating ion transport, in accordance with the present disclosure.

FIG. 14C is an operational schematic illustration of an electrochemical apparatus, in a hydrogen generation and electrolysis mode using gated-PEMs, illustrating fluidic and electric connections, in accordance with the present disclosure.

FIG. 14D is an operational schematic illustration of an electrochemical apparatus, in a hydrogen generation and electrolysis using PEMs with fixed surface charges, illustrating fluidic and electric connections, and constructed through combined modular assembly and/or nanofabrication in accordance with the present disclosure.

FIG. 15A is an operational schematic illustration of an electrochemical apparatus, in an acid/base generation mode using IEMs with fixed surface charges, and constructed through combined modular assembly and/or nanofabrication, in accordance with the present disclosure.

FIG. 15B is an operational schematic illustration of an electrochemical apparatus, in an acid/base generation mode using IEMs with fixed surface charges, as shown in FIG. 15A, illustrating ion transport, in accordance with the present disclosure.

FIG. 15C is an operational schematic illustration of an electrochemical apparatus, in an acid/base generation mode with gated-IEMs, illustrating fluidic and electric connections, in accordance with the present disclosure.

FIG. 15D is an operational schematic illustration of an electrochemical apparatus, in an acid/base generation mode using IEMs with fixed surface charges, illustrating fluidic and electric connections, and constructed through combined modular assembly and/or nanofabrication in accordance with the present disclosure.

FIG. 16A is an operational schematic illustration of an electrochemical apparatus, in a solid-state rechargeable battery mode using IEMs with fixed surface charges, and constructed through combined modular assembly and/or nanofabrication, in accordance with the present disclosure.

FIG. 16B is an operational schematic illustration of an electrochemical apparatus, in a solid-state rechargeable battery mode using IEM with fixed surface charges, as shown in FIG. 16A, illustrating ion transport in charging and discharging modes, in accordance with the present disclosure.

FIG. 16C is a side-view illustration of an electrochemical apparatus, in a solid-state rechargeable battery mode with gated-IEMs, illustrating electric connections, in accordance with the present disclosure.

FIG. 16D is a side-view illustration of an electrochemical apparatus, in a solid-state rechargeable battery mode using IEMs with fixed surface charges, illustrating electric connections, and constructed through combined modular assembly and/or nanofabrication in accordance with the present disclosure.

FIGS. 17A-17B are diagrammatical illustrations of a non-electrochemical vertical stack module for separation of hydrogen and oxygen gases from the electrode rinse solutions with no electric energy consumption, in accordance with the present disclosure.

FIGS. 17C-17D are side-views of the non-electrochemical vertical stack module for separation of hydrogen and oxygen gases from the electrode rinse solutions with no electric energy consumption, shown in FIGS. 17A-17B, in accordance with the present disclosure.

FIG. 18A is a diagrammatical illustration of a full-system electrochemical platform, for water desalination, in which one or the majority of components are based on electrochemical apparatus, with energy recovery subsystems and a chemical dosing subsystem, with representative fluidic connection examples and requiring no or minimal external chemical input, in accordance with the present disclosure.

FIG. 18B is a diagrammatical illustration of electrical connection examples in a full-system electrochemical platform for water desalination, shown in FIG. 18A, in accordance with the present disclosure.

FIG. 19A is a diagrammatical illustration of fluidic connections in a full-system electrochemical platform for sea water desalination, as shown in FIGS. 18A, between the desalination chip and the concentration gradient based energy recovery subsystem, in accordance with the present disclosure.

FIGS. 19B-19C are graphical illustrations of energy segmentation in a full-system electrochemical platform for sea water desalination, as shown in FIG. 19A, demonstrating the feasibility of achieving sub-1.1 kWh/m³ net energy consumption through integration of energy recovery subsystems, in accordance with the present disclosure.

FIG. 19D is a diagrammatical illustration of a full-system electrochemical platform for sea water desalination, incorporating energy recovery subsystems, as described in FIGS. 18A, which might operate at an overall energy consumption of substantially below 1.1 kWh/m³, such as 0.82 kWh/m³, relative to the state-of-the-art reverse-osmosis, and the conventional thermodynamic limit for the desalination stage (1.1 kWh/m³), in accordance with the present disclosure.

FIG. 20A is a flowchart illustrating a method of manufacturing an electrochemical apparatus, in accordance with the present disclosure.

FIG. 20B is a flowchart illustrating a method of manufacturing an electrochemical apparatus in desalination, and/or concentration gradient-based energy recovery, and/or acid/base generation mode(s), in accordance with the present disclosure.

FIG. 20C is a flowchart illustrating a method of manufacturing an electrochemical apparatus in fuel cell, and/or hydrogen generation and electrolysis mode, in accordance with the present disclosure.

FIG. 20D is a flowchart illustrating a method of manufacturing an electrochemical apparatus in solid-state battery mode, in accordance with the present disclosure.

FIGS. 20E-20I are flowcharts illustrating a method of operating of full-system electrochemical platform for water desalination, including energy recovery and chemical dosing subsystems, such as several electrochemical chips, including desalination, concentration gradient-based energy recovery, fuel cell, acid/base generation, and chlorine generation chips, in accordance with the present disclosure.

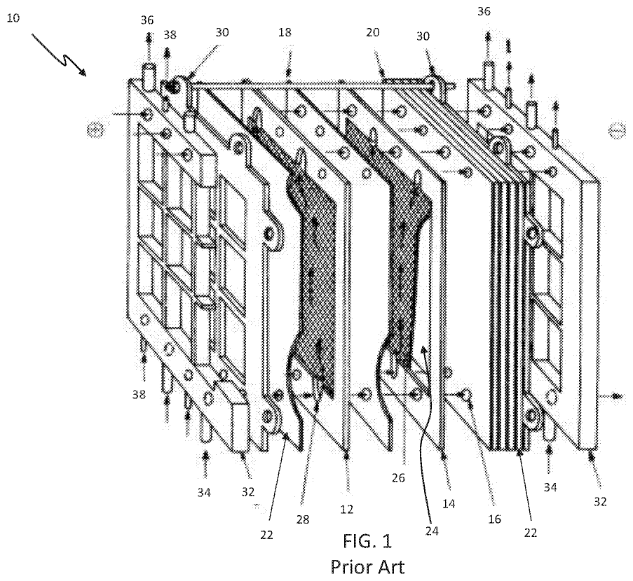

### DETAILED DESCRIPTION

To address the energy consumption reduction of electrochemical and electro-fluidic systems, such as electric desalination, and to approach the energy performance nearby the thermodynamic limits, the present disclosure is directed to make dense vertical stack architectures of micro and/or nano-ion exchange membranes (IEM). These vertical stacks may include ultra-thin fluidic compartments, ultra-thin IEM layers, ultra-thin electrodes, gaskets, and/or spacers, depending on the application. The vertical platform may enable significant downscaling of multiple structural components, including but not limited to, fluidic compartments, IEM membranes, electrodes, gaskets and spacers. Downscaling of these components within a vertical stack in an electrochemical system might enhance ion transport due to elevated at elevated electric strengths, and/or reduce ionic electrical resistance by reducing ion transport paths. In addition to the potential energy performance gain, the vertical configuration may enable more efficient and lower-cost fabrication methods, including nanofabrication, batch processing using foundry services, modular assembly, a combined nanofabrication with modular assembly, or the other methods. Although the electrochemical apparatus is constructed in a vertical configuration, the resulting electrochemical apparatus may operate in any orientation, such as vertical, horizontal or slanted. In certain implementations, a vertical orientation might provide operational advantages such as gravity-assisted flows and reduced pumping energy.

For a full-system operation of an electrochemical platform, such as water desalination, one or more electrochemical apparatuses might get configured to operate in series, parallel or the other configurations. Such a full-system may include electrochemical apparatuses configured for desalination, acid/base generation, chlorine generation, fuel cell, concentration gradient-based energy recovery, solid-state rechargeable battery purposes. Additionally, the full-system may incorporate non-electrochemical based modules, to e.g. recycle the electrode rinse solutions of the electrochemical apparatuses and optionally harvest hydrogen and oxygen for energy generation. Specifically, for sea water desalination, such a full system with energy recovery subsystems, might achieve an overall energy consumption below 1.1 kWh/m³ (which represents the thermodynamic limit for the desalination stage without energy recovery), at desalination stage recovery ratio of 50%.

Although the present disclosure primarily focuses on desalination applications, similar reductions in ionic transport distance may also provide efficiency improvements in other electrochemical systems, including chemical production devices (e.g. hydrogen generation or acid/base generation), energy conversion devices (e.g. fuel cells), and electrochemical energy storage devices such as solid-state batteries.

The figures of this disclosure are directed to the structure, fabrication methodologies, and operation of electro-fluid devices with vertically stacked ionic transport structures. Reference is made to the components and features of these figures, collectively and individually, throughout the specific descriptions of each figure.

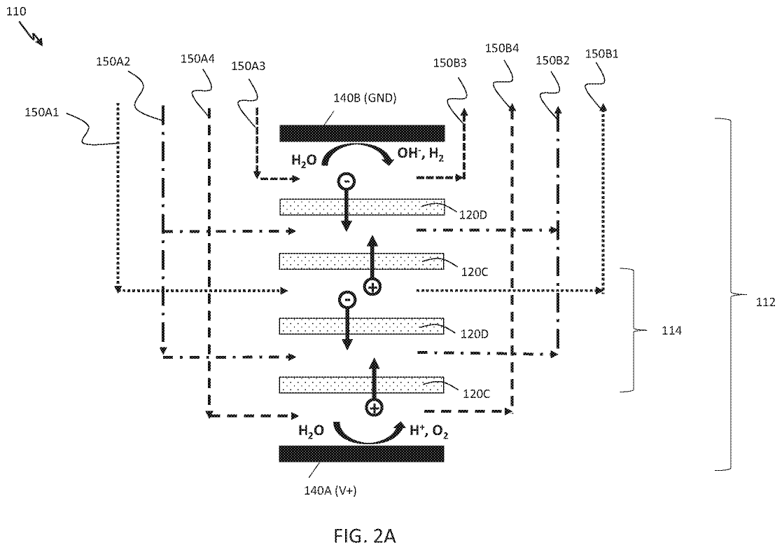

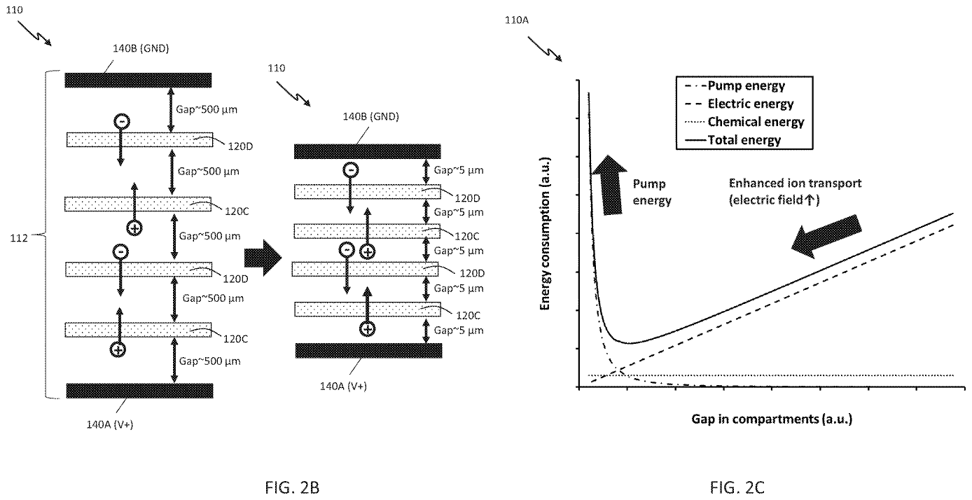

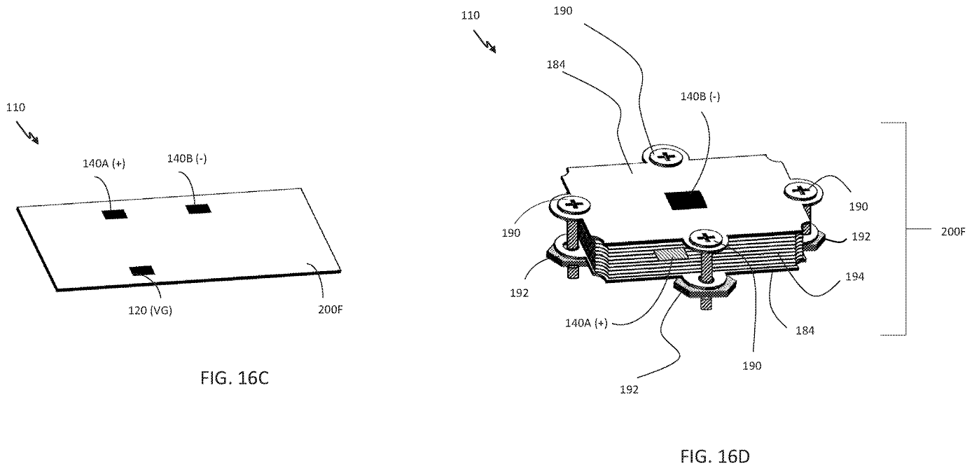

FIG. 2A is a diagrammatical illustration of an electrochemical apparatus 110 configured as an example for electric desalination ED mode, in accordance with the present disclosure. In general, the electrochemical apparatus 110, includes at least one IEM membrane 120 in substantially parallel alignment between at least two electrodes 140A and 140B to perform ion transport between the two electrodes 140A and 140B for various purposes such as desalination, energy recovery based on concentration gradient, fuel cell, hydrogen generation and electrolysis, acid/base generation, solid-state battery, or the other purposes. As described in detail herein, each application may include modifications in the structural elements in the vertical stack 110, including but not limited to, IEM 120 layers, gaskets 130, spacers 194, porous electrode 420 layers, bipolar plates 322 (FIG. 16A), ion host layers 422, 424 (FIG. 16A), electrodes 140, vertical fluidic inlets e.g. 150A1-150A4 and vertical fluidic outlets e.g. 150B1-150B4, various fluidic connections, and electrical connections.

In the electrochemical applications that may involve fluidic components, fluidic chemicals, or fluidic products, gaskets 130 may be used to define the fluidic compartments 132 within the vertical stack 112, seal the compartments at their perimeters, and establish fluid pathways. The gaskets 130 may be micro gaskets, whereby they have a least one dimension in the range of 1 mm to 1 μm, or they may be nano gaskets having at least one dimension in the range of 1 μm to 1 nm. Additionally, gaskets 130 may have a combination of dimensions and be formed as a micro/nano gasket, whereby they have at least one dimension in the range of 1 mm to 1 nm. The gasket 130 embodied as a micro gasket, nano gasket, or micro/nano gasket may be selected based on the design and intended use thereof. For instance, the gasket 130 may be formed as a micro only gasket because the thickness of compartment may preferably be in μm range, or there may be a negative effect on pumping energy. Similarly, other components of the disclosure may have similar sizing, such as spacers, electrodes, ion exchange resins (IERs), beads, porous thin-film or scaffold layers, and others.

Spacers 194 may be positioned within gaskets 130 to prevent collapsing of adjacent suspended layers, such as IEM 120 layers, or between a suspected layer e.g. an IEM 120 and a fixed layer e.g. electrode 140, due to electrostatic or hydrodynamic forces. The spacers 194 might also aid in defining the internal fluid pathways within the fluidic compartments 132.

The fluidic compartments 132 may include at least one ion exchange material, such as IER, beads, or structures, to enhance ion conduction and mechanical stability of fluidic compartments 132 including one or two adjacent suspended layers. The IER may be cation exchange resin (CER), anion exchange resin (AER) or both. It can be mixed bed, layered CER and layered AER, or the other arrangements. The IER may be implemented in the form of beads, or alternatively as other structured forms such as monoliths, thin films, porous scaffolds, patterned materials, layered structures, microtubes, nanotubes, microwires, nanowires, atomic or molecular-scale architectures, or embedded micro/nano-structures formed within or from sacrificial layers, depending on the desired application and integration method. The IER may help to reduce the electric resistance of the fluidic compartment due to e.g. local water splitting to H+ and OH ions. This dual function may enable a compact and mechanically stable design, in which spacers 194 may not be required in certain fluidic compartments 132. In particular, micro/nano-IER may be used in electric desalination (EDI) and/or ICP, energy recovery using concentration gradient, fuel cell, hydrogen generation and electrolysis, and acid/base generation. As an alternative to IER, structures such as beads, porous scaffolds, or the other structures, may be employed solely for mechanical supports and compartment definition, without contributing into ionic conduction.

The IEM 120 layers in the vertical stack 112 may be designed to have fixed surface charges (e.g. functionalized polymer layers) or gated-IEM with tunable surface charges using an external voltage, or mixed combinations of both. Each IEM 120 may be selective to a specific charge type, e.g. a CEM (cation exchange membrane) or an AEM (anion exchange membrane), mainly due to Donnan equilibrium at the nanopores of IEM 120 to transport ions. Examples of functionalized polymer layers with negative fixed surface charges for use as CEM, can be sulfonated polymers such as Nafion® containing —SO₃⁻ groups. Examples of functionalized polymer layers with positive fixed surface charges for use as AEM, can be aminated polymers such as Sustainion® containing —NR₄⁺ groups. The IEM 120 layers may be cation exchange membrane (CEM, 120C), anion exchange membrane (AEM, 120D), proton exchange membrane (PEM, 120E), bipolar exchange membrane (BPM, 120F), or a selectively ion-conductive membrane specific to a particular ion species such as Na⁺. Alternative materials or architectures may be used as CEM or AEM, such as graphene, reduced graphene oxide (rGO), nanotubes, and nanowires, either in pristine form, with chemical functionalization, or through material engineering, to impart ion selectivity.

As shown in FIG. 2A, the vertical stack 112 may be designed to operate in desalination ED mode and it includes at least two IEM membranes 120, e.g. 120C and 120D, in substantially parallel alignment, and positioned between the at least two electrodes 140A, 140B. The vertical stack 112 includes alternate IEM membranes of 120C and 120D to operate in the electrodialysis (ED) mode. The vertical stack 112 may include multiple repeating units 114. Each repeating unit 114 comprises one CEM 120C, one AEM 120D, one dilute and one concentrate brine compartment positioned adjacent to each CEM 120C or AEM 120D. Note that the IEM 120 layers positioned at the edges of the vertical stack, and adjacent to the electrodes 140A and 140B, may require special configurations to facilitate effective ion charge transfer between the electrode compartments and the vertical stack 112. At least two electrodes of 140A and 140B are positioned at both sides of the vertical stack 112 and they are electrically biased, such as V+ and GND, respectively. At least two IEMs 120 (such as 120C and 120D) are positioned between at least two electrodes 140A and 140B. The feed water gets injected to the vertical stack 112 from inlets 150A1 and 150A2 and the outlets 150B1 and 150B2 expel the dilute, concentrate brine, respectively, from the vertical stack 112. The electrode rinse buffer solutions get injected to the vertical stack 112 from inlets 150A3 and 150A4 to the top and bottom electrode compartments and the outlets 150B3 and 150B4 expel the electrode rinse buffer solution from top and bottom electrode compartments, respectively, from the vertical stack 112. The top electrode 140A and the bottom electrode 140B may use different or the same rinse buffer solutions, and they may use feed water. In the electric desalination of such ED stack, major energy consumption mechanisms may include electric energy loss due to ion transport across the IEM stack due to ionic electrical resistance of compartments (dilute, concentrate brine, electrode compartments), hydraulic or pumping energy required to drive fluid through the desalination system and its fluidic channels or compartments, and the chemical energy loss due to electrochemical (Faradaic) half-reactions in electrodes 140A and 140B. Note that for any electric charge transfer between an electrode and the solution phase, a chemical half-reaction is required. Such chemical half-reactions in the anode (oxidation) and cathode (reduction) may be in the form of the half-reactions of EQN. 1 and EQN. 2, respectively:

H₂O(l)→½O₂(g)+2H⁺(aq)+2e⁻ (EQN. 1)

2H₂O(l)+2e⁻→H₂(g)+2OH⁻(aq) (EQN. 2)

Note that other electrochemistry mechanisms may be pursued in cathode and anode, depending on the electrode type and electrode rinse solution chemical content.

FIG. 2B is a diagrammatical illustration of an electrochemical apparatus 110 configured for electric desalination ED, showing uniform fluidic compartment gaps of 500 μm (left) and 5 μm (right), as examples of dimensions for downscaling of compartment gaps or thicknesses thereof, in accordance with the present disclosure. One of the goals of the dense vertical stack architecture is reducing the gap in the dilute, concentrate brine and electrode compartments down to e.g. 5 μm or smaller, e.g., such that a thickness of the compartment is 5 μm or smaller, which is shown in the right plot in FIG. 2B.

FIG. 2C is a graphical illustration of an electrochemical apparatus 110 in desalination ED mode, as shown in FIG. 2B, presenting a qualitative plot 110A that illustrates the relative contribution of various energy consumption mechanisms associated with uniform fluidic compartment gap reduction, in accordance with the present disclosure. By reducing the gap of dilute, concentrate brine and electrode compartments, the ion transport may be enhanced due to the elevated electric field strength and therefore, it may help to operate the desalination system at a lower voltage. In addition, reduction of the compartment gaps results ionic electrical resistance reduction of the compartments (dilute, concentrate brine, electrode compartments). Both effects may contribute to minimizing the electric energy consumption associated with ion transport. However, once the gap becomes sufficiently small, the pressure drop across the fluidic system may increase rapidly, leading to a sharp rise in the pumping energy, which may become the dominant contributor to the overall energy consumption. In the performed analysis in FIG. 2C, it is assumed that the majority of the electric potential drop occurs across the dilute compartments. Note that in an ionic solution, the ionic electrical resistance reduces by increasing the salt concentration. Therefore, it is expected to have much smaller ionic electrical resistance in concentrate brine and electrode compartments vs dilute compartments. Additionally, in the proposed vertical stack miniaturization strategy, the IEM layer (e.g. 120C, 120D) thicknesses may also get reduced, resulting its ionic electrical resistance reduction. Therefore, it may further contribute to lowering the required electric energy to perform ion transport in the vertical ED stack 112.

In the vertical ED stack 112 in FIGS. 2A-2B, reduction of gap within dilute, concentrate brine and electrode compartments is expected to have minimal impact on chemical energy consumption, which would be primarily determined by EQNS. 1-2. Note that the chemical energy required to do electrolysis at electrodes to generate e.g. H₂(g) and O₂(g) per unit of electric charge passing through a desalination vertical stack may depend on parameters e.g. pH of electrode compartments, chemical composition of electrode rinse solution, the partial gas pressures, temperature, electrode type and workfunction of the electrodes (which may induce overpotential at the electrodes). One method to reduce the chemical energy per unit of dilute flow is increasing the number of IEM 120 layers to increase the number of dilute and concentrate brine compartments between the two electrodes 140A and 140B. This approach may increase the net dilute flow, without increasing the chemical energy required per unit of electric charge passing through the desalination vertical stack 112. The implementation of a dense vertical stack strategy would help to maximize the number of IEM layers with a fixed lateral footprint, thereby help to mitigate the chemical energy losses. Note that in FIG. 2C, a uniform gap reduction was assumed across the dilute, concentrate brine and electrode compartments for the purpose of qualitative energy segmentation. However, to address some experimental challenges, in particular within the electrode compartments due to e.g. releasing bubbles due to electrochemical half-reactions, according to EQNS. 1 and 2, the electrodes might require thicker compartments than the dilute and concentrate brine compartments.

The dense vertical stack architectures, including micro and/or nano-ion exchange membranes, and the other components such as gaskets, electrodes, spacers, may be formed using scalable nanofabrication, semiconductor techniques, modular assembly, combined techniques or the other suitable methods. In addition to energy consumption optimization by the dense vertical stack architectures, the proposed fabrication methods may also lower the costs of manufacturing of electric desalination systems.

For electric desalination, the vertical stack may include structural elements including but not limited to a vertical stack of ion exchange membranes, vertical fluidic channels to access fluidic compartments within the chip, gaskets positioned between IEMs and electrodes, spacers within micro-gaskets, and at least two electrodes at both sides of the vertical stack. Spacers may be positioned within gaskets together with IER, or structures without ion exchange capability. The IEM layers may be formed from nanoporous structures that may exhibit fixed surface charges (e.g. sulfonated layers), electrically gated-IEM nanopores with tunable surface charges, or mixed combinations of both. For desalination, the device architecture has the flexibility to operate in multiple modes including ED, EDI, ICP or in mixed modes.

In comparison to conventional electric desalination structures and assembly methods, the methodology employed by the present disclosure may significantly improve manufacturing using e.g. foundry services, which enables a reduction of the cost of manufacturing and may significantly reduce the system footprint. Moreover, this approach may reduce the energy required for desalination by minimizing the spacing between IEM layers and reducing the thickness of individual IEM layers, and therefore, enhancing ion transport under a strengthened electric field. The better energy efficiency compared to conventional devices may reflect lower cost to deliver clean water from sea or other water resources to customers. Therefore, in addition to the drinking water sector, the present disclosure may also be capable of saving significant costs in multiple industry sectors, such as ultra-pure water for semiconductor and chemical industries, high-pure water for pharmaceutical industries, clean water for food and beverage, wastewater recovery, and several industries such as oil/gas, mining/metal, pulp/paper that intensely consume water. It should also help municipal water management systems to provide low-cost drinking water to millions of people living in water-stressed regions.

In electric desalination operation mode, the ions and charged particles enter the chip from an inlet, or multiple inlets, and they may pass through the vertical stack of suspended ion exchange membranes. The ion transport, driven by an electric field, results in separate dilute and concentrate brine flows. By using distinct gasket designs, the two flows can be independently collected at the dilute outlet and the concentrate brine outlet. The chip may use a separate buffer flow to rinse the electrodes at each side of the stack. This design may mitigate energy consumption, optimize and reduce the manufacturing method in comparison to the traditional methods to physically assemble each large component.

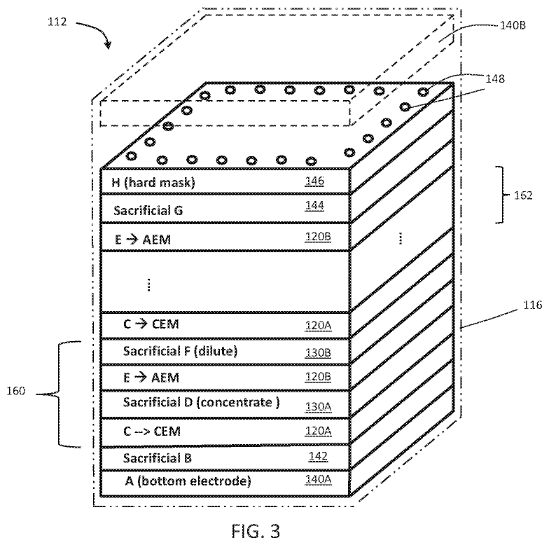

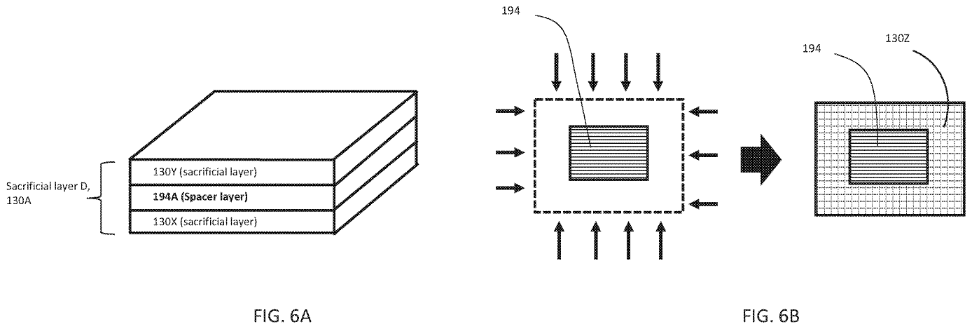

FIG. 3 is a diagrammatical illustration of the construction of a vertical stack 112 for forming an electrochemical apparatus 110, such as electric desalination ED, using nanofabrication methods, in accordance with the present disclosure. In construction, the vertical stack 112 has an electrode layer 140A to act as the bottom electrode. Sacrificial layer B, 142, may be used to form the electrode compartment for the electrode 140A. Layers C, 120A, and layers E, 120B, reflect the porous, thin film layers, such as porous scaffold thin films, that are used to form suspended IEM membranes 120, and in particular, CEM 120C and AEM 120D in this example. Sacrificial layers D, 130A, and sacrificial layers F, 130B, are used to form gaskets 130, and/or spacers 194 (FIG. 6), between the IEM membranes 120. The layers 120A, 130A, 120B, and 130B may be referred to a repeating unit of layers 160 in the vertical stack 112. Such layers in one reaping unit of layers 160, may be deposited multiple times to create an array of vertical ED units, which may be repeated within the vertical stack 112 any number of times, as indicated at 162. Finally, a sacrificial layer G, 144, may be deposited on top of the vertical stack 112, followed by deposition of a hard mask layer 146.

Since several process steps may be used to produce suspended structures, to improve mechanical stability of the stack, a lithography and thin film deposition may be performed to introduce several dummy pillars 148 to the vertical stack 112, especially around the perimeter of the vertical stack 112, or at the other locations, as needed. After completion of several process steps, as will be described in further detail herein, the electrode layer 140B (depicted in dash-dash broken lines) may be formed to complete the vertical stack 112. Note that the electrode layer 140B may not extend across the entire top surface of the vertical stack 112 and the depiction in broken lines in FIG. 3 is provided for illustrative purposes only.

For the metal deposition, methods like physical vapor deposition (PVD), chemical vapor deposition (CVD) or electroplating may be used. For the alternate stacks of sacrificial and porous layers, a single tool like CVD may be used to save time, since each deposition tool typically may require reaching a certain vacuum level prior to starting the deposition. Multiple deposition tools may be used, depending on the intended design and manufacturing process, all of which are considered within the scope of the present disclosure.

The electrochemical apparatus 110 may include one or more vertical stacks 112, which may be deposited on a support wafer, such as a silicon wafer, a thermal oxide wafer, glass or any type of substrate. It is noted that to perform the deposition process, several additional layers may be used, including but not limited to, etch stop layers, adhesion layers, and/or protection layers. After deposition of the vertical stack 112, a lithography and vertical etching may be performed to create several individual vertical stacks 112 with lateral empty spaces on the substrate.

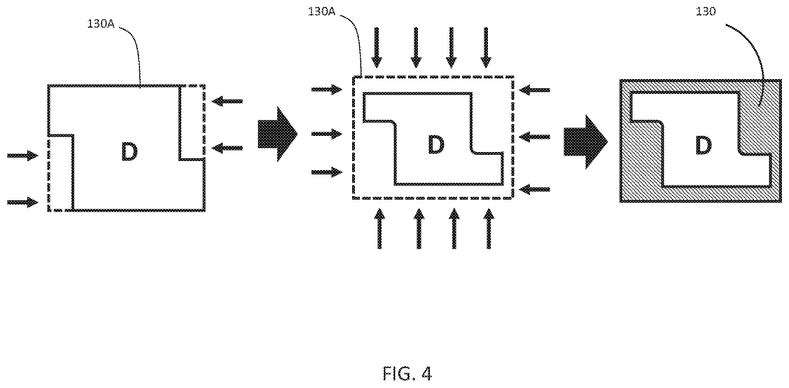

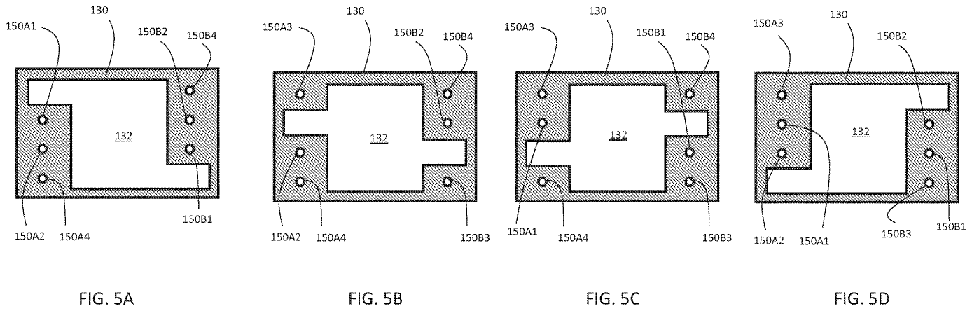

Formation of the gaskets 130 is described in FIGS. 4-5D, where these figures are top-view illustrations of the process for forming gaskets 130, may be used in electrochemical apparatus 110, in accordance with the present disclosure. Considering desalination as one of the examples of electrochemical systems, the gaskets 130 define the dilute, concentrate brine and electrode compartments, seal the compartments at their perimeters, and establish fluid pathways.

FIG. 4 is a top-view illustration of a process for forming gaskets 130 for use in an electrochemical apparatus 110, such as for electric desalination ED, in accordance with the present disclosure. With reference to FIGS. 2A-FIG. 4, FIG. 4 depicts a process example, including lithography and local isotropic etching of multiple sacrificial layers D, 130A, in the vertical stack 112, followed by strip resist and partial conformal etching of multiple sacrificial layers D, 130A, in the vertical stack 112 from all sides to create undercuts. Afterward, a conformal thin film isotropic deposition of 130C may be done to fill all the etched regions in sacrificial layers D, 130A, in the vertical stack 112 (acting as sealant or perimeter thin film), to form gaskets 130.

FIGS. 5A-5D are top-view illustrations of example gasket 130 configurations for use in an electrochemical apparatus 110, such as for electric desalination ED, in accordance with the present disclosure. The four exemplary gaskets 130 designs might get formed from the sacrificial layers D, F, B and G. Considering desalination as one of the examples of electrochemical systems, these gaskets 130 may be used for concentrate brine compartment (FIG. 5C), the dilute compartment (FIG. 5B), top electrode rinse compartment (FIG. 5A) and bottom electrode rinse compartment (FIG. 5D). The example of FIGS. 5A-5D assumes only four main compartments are needed to operate the electrochemical apparatus 110, but depending on the device and stack design and potential needs for multiple fluidic inlets and outlets 150 for nanofabrication steps, the gaskets 130 may be modified to support selected access to specific layers in the vertical stack 112. In FIGS. 5A-5D, a conformal isotropic thin film deposition of 130C may be done to create all four gaskets 130. It is noted that each sacrificial layer (D, F, B and G) may require its own gasket 130 formation and a separate sealant or perimeter thin film may be used (but not a single thin film of 130C for all sacrificial layers).

While the gaskets 130 seal the compartments in an electrochemical system and define the fluid pathways between layers in a vertical stack 112, spacers 194 may be employed to further define the fluid pathways within each compartment, precisely control the compartment gap, and prevent collapsing of the suspended IEM membranes 120 due to electrostatic or hydrodynamic forces.

FIGS. 6A-6B are illustrations of a process for forming spacers 194 for use in an electrochemical apparatus 110, such as for electric desalination ED, in accordance with the present disclosure. In FIG. 6A, the sacrificial layer D, 130A may be defined as the stack of a spacer layer 194A, sandwiched between two sacrificial layers 130X and 130Y. In FIG. 6B, the sacrificial layer 194A may be partially etched isotopically from all sides to form the spacer 194. Afterward, isotropic deposition of a sacrificial layer 130Z may be done to fill the gap in the vertical stack between 130X and 130Y layers. Note that spacers 194 may be used in multiple compartments. In particular for desalination purposes, they may be used in either dilute, concentrate brine, electrode compartments, some, all or none of the compartments. The formation of spacers 194 may be done prior formation of gaskets 130. However, depending on the process conditions or requirements, the spacer formation alternatively may be performed after the gasket formation.

The IEM layers 120 in the vertical stack 112 may be designed to have fixed surface charges (e.g. functionalized polymer layers) or gated-IEM with tunable surface charges, or mixed combinations of both. Examples of functionalized polymer layers with negative fixed surface charges for use as CEM, can be sulfonated polymers such as Nafion® containing —SO₃⁻ groups. Examples of functionalized polymer layers with positive fixed surface charges for use as AEM, can be aminated polymers such as Sustainion® containing —NR₄⁺ groups.

To make fixed surface charge IEM layers, a lithography and etching step may be employed to create an inlet and an outlet at the top of the vertical stack 112. This step may be followed by anisotropic etching of the entire vertical stack 112 to create the vias for the vertical fluidic channels 150. Multiple inlets and/or outlets may be used, and the inlets and/or outlets would have direct access to layers C 120A, but not to layers E 120B, due to gasket 130 architecture. A solution including the CEM material (such as Nafion®) may be used to either cross-link or coat the layers C 120A with CEM materials to form the CEM layer 120C. Multiple techniques may be used, such as immersing in liquid or pumping. Afterward, it may also be possible to do an annealing step. After completion, the inlet may be closed by a lithography and thin film deposition. The same technique may be used to perform lithography, create inlets/outlets to access E layers 120B), but not layers C 120A, introduce an AEM material (such as Sustainion®) to cross-link or coat the layers E with AEM materials, to form the AEM layers 120D.

The formation of CEM and AEM layers of 120C and 120D from layers C and E may be achieved through various methods depending on the desired material system and integration requirements. These layers may serve as porous scaffolds that are infiltrated with ion-conducting precursors, followed by curing or cross-linking to form a solid membrane structure. In addition to cross-linking, alternative techniques may include in-situ polymerization, layer-by-layer assembly, sol-gel processing, surface grafting, or vapor-phase infiltration. The porous scaffolds themselves may be fabricated using methods such as electrospinning, colloidal templating, track-etching, or nanoparticle sintering. These approaches allow tuning of membrane thickness, porosity, and charge selectivity.

Using fabrication methods similar to those employed to make IEM layers 120 with fixed surface charges, gated-IEM layers may be formed with modifications to some process steps. For example, scaffold layers C 120A may include an electrically conductive material with a nanoporous structure. Such electrically conductive material may include but is not limited to metals, semiconductors, carbon-based materials such as graphene or carbon nanotubes, conductive polymers, nanostructured conductors, or other materials capable of supporting electrical biasing. After creating the vias for the vertical fluidic channels 150 using lithography and anisotropic etching to have exclusive access to the layers C 120A, but not layers E 120B, a conformal insulating layer, such as sub-5 nm of HfO₂, may be deposited via atomic layer deposition (ALD) or another suitable method. This coating may insulate the scaffold from a direct fluidic contact while reducing the nanopore diameter into e.g. sub-10 nm range. Scaffold layers C 120A and E 120B may be processed simultaneously or independently, depending on the desired membrane configuration. The insulating layer enables the formation of tunable surface charge within the nanopores by applying an electrical bias to the scaffold, while preventing Faradaic reactions by isolating the electrode material from the liquid phase. The resulting gated-IEM layers 120 may be electrically biased individually or in coordinated groups, for instance all CEM layers as one group, all AEM layers as another, or subdivided into smaller independently addressable arrays. This electrostatic gating may modulate the surface potential at the dielectric-electrolyte interface, enabling the formation of a tunable Donnan-like potential without direct charge injection or electrochemical reaction.

Formation of some compartments, such as dilute and concentration brine compartments for desalination purpose, may utilize a lithography mask to create an inlet and an outlet at the top of the vertical stack 112. It may be followed by anisotropic etching of the entire vertical stack 112. To form the concentrate brine compartments, multiple inlets and/or outlets may be used and they should have direct access to the sacrificial layers D 130A, but not layers F 130B. An isotropic etching may be done to etch the entire sacrificial layers D 130A in the vertical stack 112 to create the concentrate brine compartments. The same technique can be used to create dilute compartments, by performing lithography, etching to create a pair or multiple inlets/outlets to access sacrificial layers F 130B, but not layers D 130A, followed by isotropic etching of layers F 130B.

Lithography may also be used for the formation of the top electrode 140B and for forming the electrode compartments. For example, a lithography step may be used to pattern the top layer, etch the hard mask layer H 146 in FIG. 3, and followed by deposition of the top electrode layer 140B. Lithography may be used to pattern one or more vias of vertical fluidic channels 150 to access the sacrificial layers B 142 and G 144. Afterward, it may be followed by isotropic etching of these layers to create electrode compartments. The top and bottom electrode compartments may be connected together or they may be separated.

To seal the vertical stack 112 in FIG. 3, a conformal layer 116 (indicated with dash-dot-dot broken lines) such as SiN may be deposited on the entire vertical stack 112 with possibly residual thin film stress such as compressive stress. Upon deposition, such thin films may tend to elongate on the wafer and therefore, it may aid with compressing and sealing the entire vertical stack 112. In other words, such thin film may act as a fastening frame to the entire vertical stack.

In certain embodiments, pressure sensing or control components may be integrated upstream or downstream of the electrochemical chip to monitor inlet or outlet pressures. These components may serve to prevent overpressure conditions that could damage the device, and may also assist in maintaining balanced flow across multiple compartments or fluidic channels. While traditional electrochemical systems, such as ED, may use external mechanical compression e.g. oil pressure press to adjust the pressure and to maintain membrane sealing, the electrochemical apparatus 110 with the chip-scale vertical stack 112 is monolithically fabricated and may not require external clamping, though pressure balancing mechanisms may still be employed to ensure stable operation under varying input conditions.

It may be possible to operate multiple stacks of vertical stacks 112. Since stacking several layers on top of each other may result in topography, process uniformity or other constraint issues, after completing one vertical stack 112 with electrodes and fastening frame deposition, it may be possible to do one step thin film deposition, e.g. low temperature oxide (LTO) and planarization to make the wafer ready for further process steps. Afterward, another set of vertical stacks 112 may be deposited, followed by the same process flow. Note that each individual stack may or may not include two electrodes 140A, 140B, but the entire “set of stacks” may require at least two electrodes 140A, 140B in total, with one electrode 140A at the bottom of the entire set of stacks and one electrode 140B at the top of the set of stacks to be able to apply an electric field to the entire set of stacks.

The operation of multiple stacks of stacks may be done in parallel to increase the net flow. They may be also operated in series to enhance the amount of salt removal, if each stage can perform partial salt removal, to be able to reach the salt concentration requirement specs of the customers. Note that some uses of the electrochemical apparatus 110 in electric desalination may require ultra-pure water and to remove all ions and charged particles (such as semiconductor industry), and multiple stages of desalination may be required. Similar to the potential to run multiple mode of operation in each stack, the multiple stacks can also run in multiple modes such as ED, EDI, ICP and ICP with ion exchange resin.

The desalination chip may have other components integrated on it. For instance, the chip may include multiple layers of devices. On the substrate and prior to starting the stack of desalination layer, a Complementary Metal-Oxide-Semiconductor (CMOS) circuitry layer may be fabricated to operate the desalination device. After completion of the desalination stack(s), a separate layer may be added to include on-chip sensors such as temperature, pH, resistivity measurement to estimate total dissolved solids (TDS) in the main inlet/outlet flows (input water, dilute outlet, concentrate brine outlet), concentration measurement for a few specific chemicals or ions (such as scalant-concerning ions including calcium, magnesium, sulfate and carbonate, chlorine, specific toxic materials that may require tracing, gas bubbles, etc.). The on-chip sensing can be performed on the flows coming in/out of each stack, coming out of multiple stacks of stacks, or may be done on some or all individual cells. Multiple configurations may be employed to integrate on-chip sensing, circuitry, and the desalination stack. In some embodiments, the circuitry and sensors may be fabricated underneath the desalination stack within the same substrate. In other configurations, the circuitry and on-chip sensors may be positioned laterally on the same substrate, operating in parallel with the desalination stack. Alternatively, the circuitry, sensing elements, and desalination components may be fabricated on separate substrates and subsequently bonded together, or they may function independently while remaining interoperable. The invention encompasses any architecture that enables integration or modular operation of sensing, control, and desalination functions, whether monolithically integrated or heterogeneously assembled.

To enhance ion transport and boost energy efficiency, the vertical stack 112 architecture described herein may be designed to minimize the spacing between alternating IEM 120 layers and reduce the thickness of each individual IEM 120 layers. This compact stacking enables more efficient ion transport, due to optimized or enhanced electric field. The fabrication of such vertical stacks is not limited to a single method. Various thin-film deposition or lamination techniques may be used, including but not limited to spin coating, spray coating, dip coating, blade coating, vapor phase deposition, or bonding of pre-formed IEM 120 layers. These methods may be used alone or in combination to achieve precise control over layer thickness and alignment. Additional techniques such as soft lithography, sacrificial layer processing, or molding may be incorporated to define fluidic pathways and maintain layer registration. While this disclosure describes the electrochemical apparatus 110 and related methodology using certain examples, it is noted that the electrochemical apparatus 110 may include or encompass configuration or fabrication approach that enables vertically stacked IEMs with reduced feature size and enhanced transport performance, all of which are considered within the scope of the present disclosure.

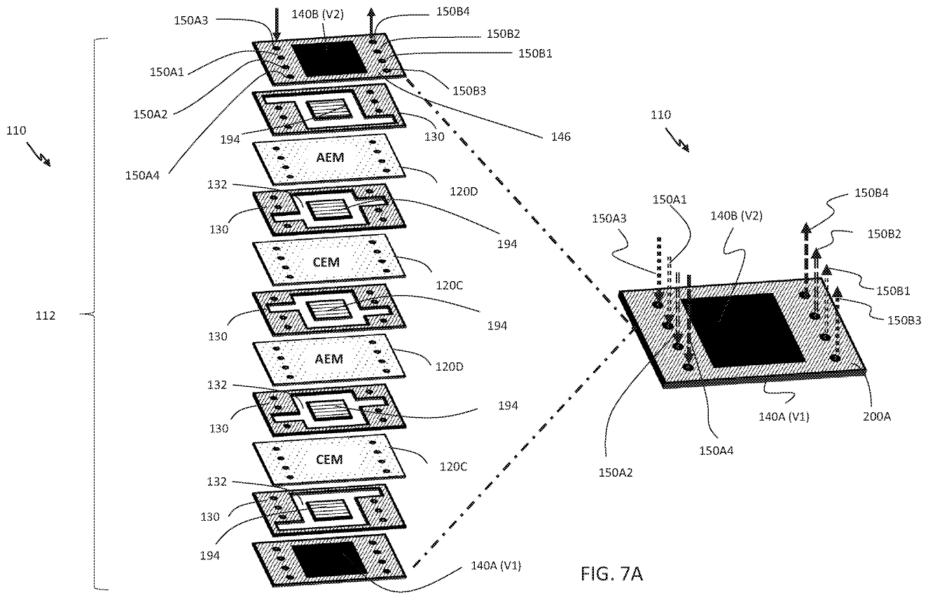

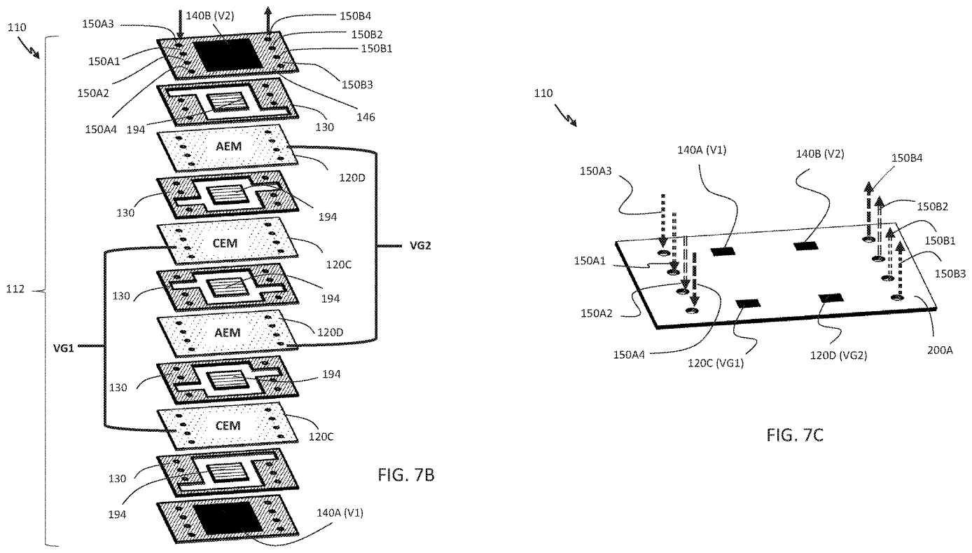

FIGS. 7A-7C illustrate an exemplary structure of the electrochemical apparatus 110, for desalination purposes, having the vertical stack 112 which are operated in ED mode, in accordance with the present disclosure. As shown, the general structure of the vertical stack 112 includes at least two IEMs 120 positioned in substantially parallel alignment, e.g., CEM 120C, AEM 120D, along with additional IEMs 120 which may be included. At least one gasket 130 is positioned between the at least two IEMs 120. The at least two IEMs 120 and the at least one gasket 130 are positioned between at least two electrodes 140A, 140B. FIG. 2B is a diagrammatical illustration of the electrochemical apparatus 110 in electric desalination ED mode depicted in FIG. 7A illustrating ion transport, in accordance with the present disclosure. Such vertical ED stack 112, as shown in FIGS. 2A and 7A, may include several repeating units 114. Each repeating unit 114 in the vertical stack 112 in FIGS. 2A and 7A-7C in electric desalination ED mode comprises one CEM 120C, one AEM 120D, one dilute and one concentrate brine compartment positioned adjacent to each CEM 120C or AEM 120D. The inlets 150A1 and 150A2 supply feed water to the dilute and brine compartments, respectively, and the outlets 150B1 and 150B2 expels dilute and concentrate brine, respectively. The inlets 150A3 and 150A4 supply electrode rinse solutions to the top electrode 140A and the bottom electrode 140B, respectively, and the outlets 150B3 and 150B4 expel electrode rinse solutions from the top electrode 140A and the bottom electrode 140B, respectively.

FIG. 7A is an operational schematic illustration of an electrochemical apparatus 110, in electric desalination ED mode using IEMs with fixed surface charges, in accordance with the present disclosure. The desalination chip 200A is shown as an assembled or fabricated example in the right, with the corresponding vertical stack 112 and its internal structures and layers in the left as examples. One electrical bias voltage scheme example that may be applied to electrodes 140A and 140B can be V1=V+ and V2=GND, respectively. The gaskets 130 and spacers 192 define the fluidic paths within compartments (e.g. electrode, dilute, and concentrate brine compartments).

FIG. 7B is an operational schematic illustration of an electrochemical apparatus 110, in electric desalination ED mode using gated-IEMs with tunable surface charges, in accordance with the present disclosure. The ion transport in the electric desalination ED mode by gated-IEMs are similar to the IEM layers with fixed surface charges, as depicted in FIG. 2A. In the example of FIG. 7B, all gated-CEM layers 120C may be electrically biased at VG1 and all gated-AEM layers 120D may be electrically biased at VG2. It is noted that in other examples, each individual IEM layer may be electrically biased independently or they may be biased in groups.

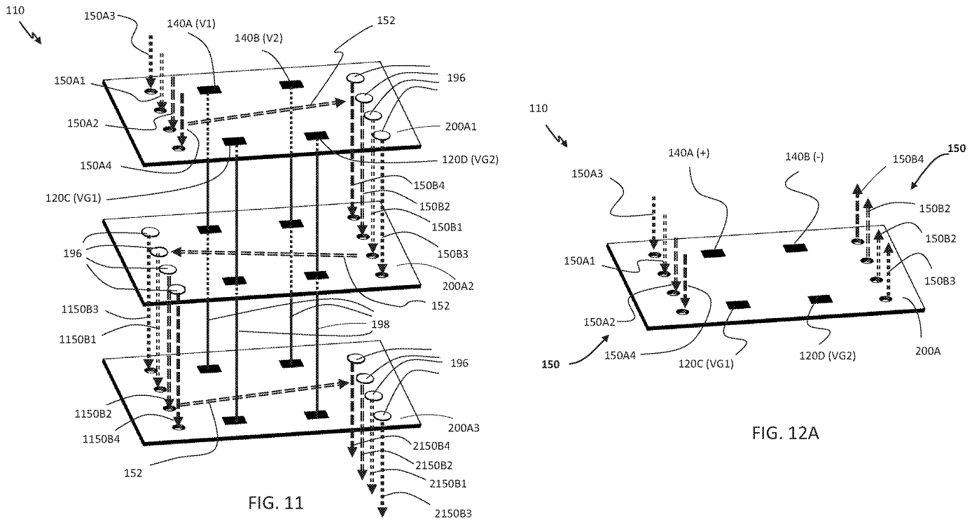

FIG. 7C is an operational schematic illustration of an electrochemical apparatus 110, in electric desalination ED mode, as shown in FIG. 7A, illustrating fluidic inlets 150A1-150A4, fluidic outlets 150B1-150B4, electric connections to electrode 140A, electrode 140B, gated-CEM 120C and gated-AEM 120D on the top-side of the electrochemical chip, in accordance with the present disclosure. Note that in case of using IEM membranes 120 with fixed surface charges (such as Nafion® or Sustainion®), it may not be required to apply a voltage to the IEM layers 120. The fluidic or electric connections in the desalination chip 200A may be positioned on the top-side, bottom-side, or both sides or any sides of the chip. Various routing scheme, ordering sequences, or arrangements of the electrical and fluidic connections and interfaces may be implemented on each chip 200A, and in general each electrochemical apparatus 110, and the FIG. 7C illustrates an example. Note that in the righthand section of FIG. 7A and FIG. 7C, various configurations of the desalination chip 200A are shown including variations in the size and location of the electric contacts to the electrode layers 140A and 140B, as well as differences in the top surface layer of the desalination chip 200A, to address additional possible packaging or sealing layers. In cases where through-chip fluidic connections 150 are used, cap layers 196 may be placed on one side of the inlets 150A1-150A4 and outlets 150B1-150B4 to direct the flow from inlets to the chip. The cap layers 196 (FIG. 11) may include fluid connector seals, plug structures, direct mechanical placements, adhesive bonding, clamping with external fixtures, or the other methods.

FIGS. 7A-7C may have many of the same components or process steps as discussed relative to FIGS. 3-6B, the discussion of which is incorporated without duplication for clarity in disclosure. In EDI mode of FIGS. 7A-7C, the architecture of the vertical stack 112 may be similar to the ED mode of FIG. 3, while IERs are added to at least one dilute compartment, and optionally in the other compartments such as concentrate brine and electrode compartments. The ion exchange resins can be a CER, an AER, or both. It can be mixed bed, layered CER and layered AER, or the other arrangements. The dimensions of the ion exchange resins may be sufficiently large enough to fill the gaps between the ion exchange membranes 120C-120D, between electrode 140A and IEM 120C, between electrode 140B and IEM 120D, by one or more resins while their dimensions should not be too small to get injected to the water outlets. To prevent escaping the resins to the outlets, an array of dummy pillars may be used nearby the inlets and outlets as well as other possible methods. The electrical and structural benefits of integrating IER within the vertical stack 112 were described earlier and are not repeated here for the sake of clarity in disclosure.

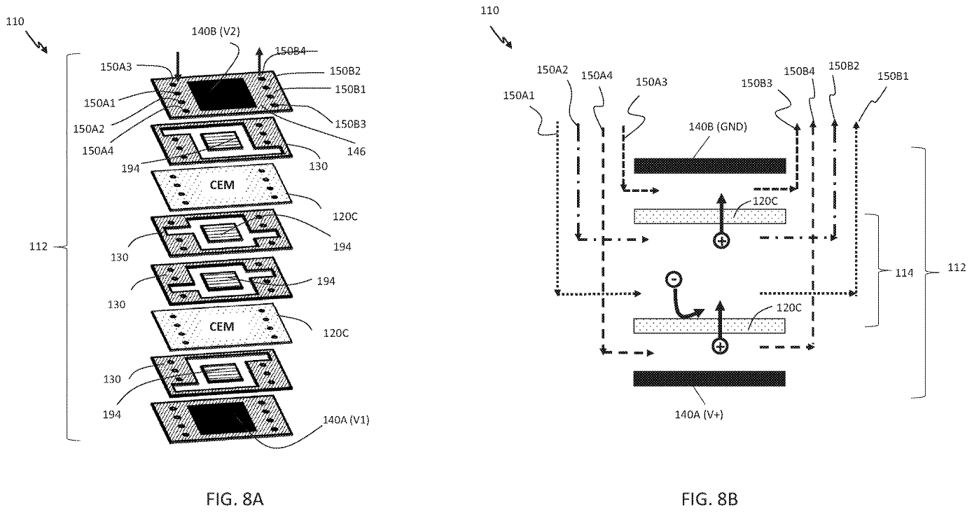

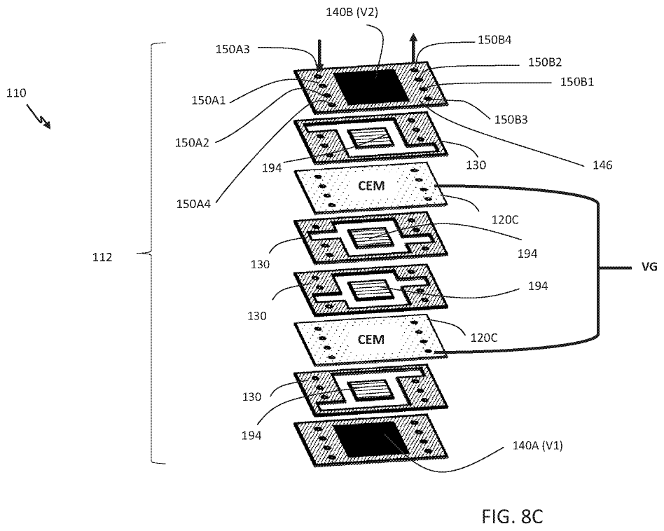

FIGS. 8A-8C illustrate operational schematics of the electrochemical apparatus 110, having the vertical stack 112 which are operated in desalination ICP mode, in accordance with the present disclosure. FIGS. 8A-8C may have many of the same components or process steps as discussed relative to FIGS. 3-7C, the discussion of which is incorporated without duplication for clarity in disclosure. The vertical stack 112 may include several repeating units 114, in electric desalination ICP mode. In the vertical stack 112 for desalination ICP mode, each repeating unit 114 comprises two IEM 120 (e.g. two CEM 120C, or two CEM 120D), and one fluidic compartment (including both dilute and concentrate brine streams) positioned between the adjacent IEM 120 layers (e.g. two CEM 120C, or two CEM 120D). In the ICP mode, only one type of ion exchange membrane, e.g., CEM 120C or AEM 120D, but not both, is used while both the dilute and concentrate brine streams are formed between each IEM membrane.

FIG. 8A is an operational schematic illustration of an electrochemical apparatus 110, in electric desalination ICP mode using IEMs with fixed surface charges, in accordance with the present disclosure. FIG. 8B is an operational schematic illustration of an electrochemical apparatus 110, in electric desalination ICP mode, as shown in FIG. 8A, illustrating ion transport, in accordance with the present disclosure. As shown, the vertical stack 112 operating in ICP mode includes CEM layers 120C with fixed surface charges in nanopores. One electrical bias voltage scheme example that may be applied to electrodes 140A and 140B can be V1=V+ and V2-GND, respectively.

FIG. 8C is an operational schematic illustration of an electrochemical apparatus 110, in electric desalination ICP mode using gated-IEMs with tunable surface charges, in accordance with the present disclosure. The ion transport in a gated-IEM architecture for ICP follows similar ion transport in ICP architectures using IEMs with fixed surface charges in FIG. 8B, in accordance with the present disclosure. Here, the vertical stack 112 for operation in ICP mode includes gated-IEM layers with tunable surface charges in nanopores. In this figure, all gated-CEM layers 120C are biased at VG voltage. It is noted that this is an example of a voltage bias scheme, and in other examples, each individual IEM layer may be biased independently or they may be biased in grouped.

In the ICP mode of FIGS. 8A-8C, IER may be used within the dilute, concentrate brine, electrode compartments, in some, all or none of the compartments. The process flow is flexible and it is possible to operate some layers in ED mode, some layers in ICP mode, some layers in EDI mode and some layers in ICP mode with ion exchange resin.

FIG. 7C can be used as the operational schematic illustration of an electrochemical apparatus 110, for both electric desalination ED and ICP modes, as shown in FIGS. 7A and 8A, respectively, and in accordance with the present disclosure. While the internal IEM architectures in ICP and ED vary, the schematic illustration of the electrochemical chip, considering fluidic inlets 150A1-150A4, fluidic outlets 150B1-150B4, electric connections to electrode 140A, electrode 140B, gated-CEM 120C and gated-AEM 120D on the top-side of the electrochemical chip, are substantially similar in both designs, in accordance with the present disclosure.

In addition to fabricating the entire vertical stack 112 using nanofabrication methods, described relative to FIGS. 3-8C, it may be possible to use hybrid methods of nanofabrication and modular assembly techniques to mitigate potential nanofabrication challenges. These include possible limitations arising from elevated stack height or surface topography, which may complicate lithography, thin film deposition, etching, planarization or the other processes.

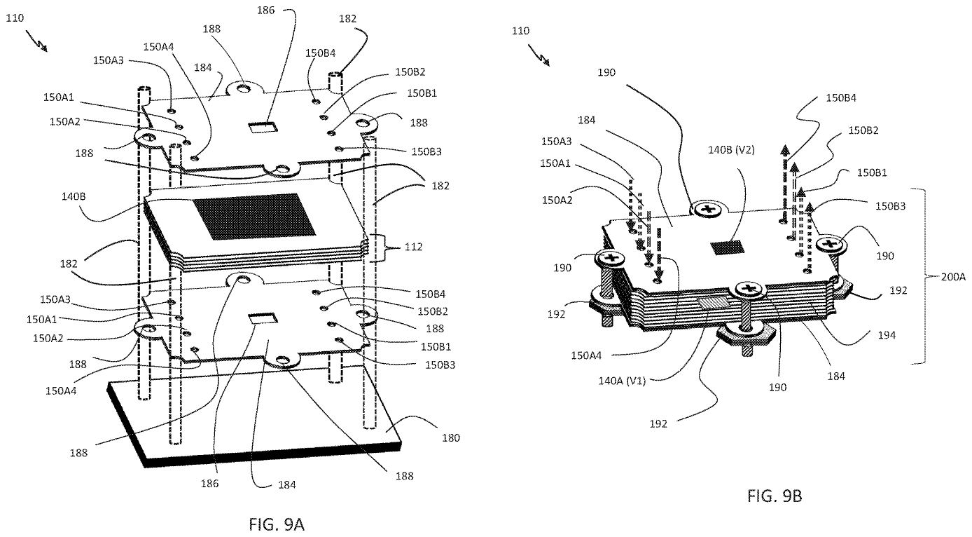

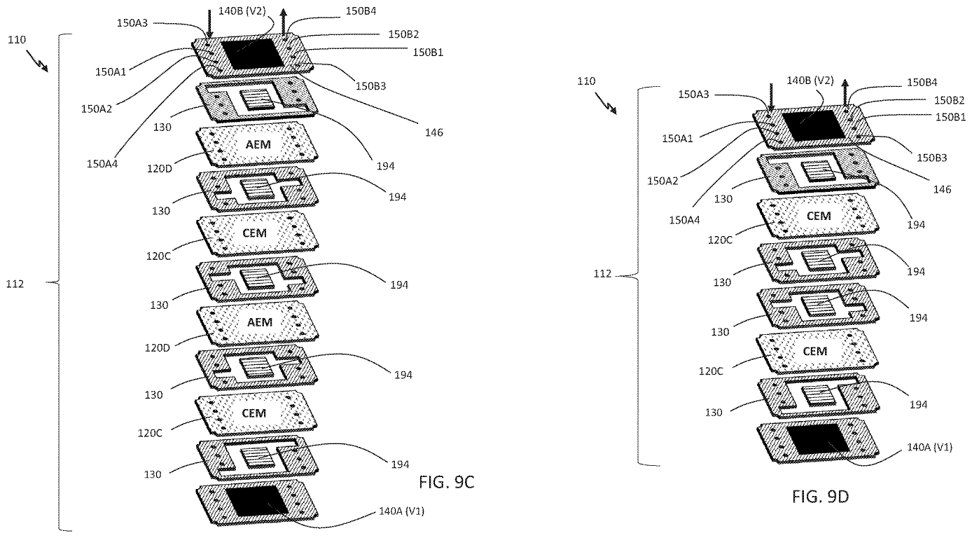

FIG. 9A is a diagrammatical illustration of the construction of a vertical stack 112 for forming an electrochemical apparatus 110, such as electric desalination, using combined modular assembly and/or nanofabrication methods, in accordance with the present disclosure. These methods may utilize commercially available ultra-thin IEM sheets, ultra-thin sheets for forming gaskets and spacers such as polymeric layers, electrode layers and customized structural components such as cover layers, alignment pins and a base alignment fixture.

As shown in FIG. 9A, a base alignment fixture 180 with fixed vertical alignment pins 182, positioned at corners, edges or the other locations, may be fabricated using various techniques, e.g. a 3D printer. The cover plates 184 may be fabricated similar techniques. The vertical pins 182 guide the placement of cover plates 184, IEM layers 120, electrode layers 140A and 140B, gasket layers 130, and/or spacer layers 194, ensuring proper registration.

The cover layers 184 may behave patterned inlet and outlet vias 150A1-150A4, 150B1-150B4, electrode vias 186 and fastening vias 188. The electrode vias 186 may be temporary filled with a soft material e.g. PDMS (Polydimethylsiloxane), to protect the beneath electrode layers (140A or 140B or both) in the upcoming etching steps. The cover plates 184, fastening bolts 190 and fastening nuts 192 may be coated with a conformal hardmask, such as a 200 nm thick aluminum oxide (Al₂O₃) film deposited using e.g. a low temperature method such as chemical vapor deposition (CVD), to ensure chemical and physical resistance to the upcoming possible dry etching environments.

The thickness of each ultra-thin IEM layer 120, gasket layer 130, spacer 194 can be in sub-200 μm range (such as only 20 μm or smaller). The ultra-thin gasket layers 130 and spacers 194 can be e.g. commercial PTFE (Polytetrafluoroethylene) layers. The IEM layers 120, gaskets 130 and spacers 194 may be patterned individually or in a group with e.g. rounded edges of specially IEM layers 120 and gaskets 130, for further alignments to the alignment pins 182, using e.g. a precision laser cutting tool. Note that spacers 194 may typically get placed inside the gasket layers 130. IERs, or alternative structures for structural enhancement, may be included between multiple layers within the gaskets 130 as well.

The vertical stack 112 may be manually assembled using the base alignment fixture 180, including the cover plates 184, IEM layers 120, gaskets 130, spacers 194, and electrode layers 140A and 140B. Each gasket layer 130 may contain embedded spacer 194, such as patterned PTFE sheets, to define the fluid channel thicknesses and fluid pathways within the compartment. At the top and bottom of the vertical stack 112, electrode layers 140A and 140B, such as graphite, conductive composites or metal layers, may be embedded within support frames (e.g. PTFE) of matching thickness, where these frames may be e.g. laser-cut to provide a central opening slightly larger than the electrode dimensions. Additional isolating sheets (e.g. PTFE) may be stacked above the top electrode frame and below the bottom electrode frame to laterally or vertically seal the perimeter and define the electrode contact region. The isolating layers may have electrode via to be able to access the electrodes 140A and 140B.

Once the vertical stack 112 with the cover plates 184 may be placed onto the base alignment fixture 180, and aligned using alignment pins 182, a sealant material 194 such as epoxy resin may be applied to all exposed side perimeters of the vertical stack 112 and, optionally, to the top and bottom edges or the other locations. The cover plates 184, which are positioned at both sides of the vertical stack 112, and the vertical stack 112 may be mechanically compressed using, for example, four titanium or aluminum fastening bolts 190 and fastening nuts 192 passing through fastening holes 188 in the cover plates 184 at the top and the bottom of the stack, positioned maybe outside the active membrane areas. The fully clamped assembly may then get cured either by thermal annealing or by allowing the sealant to harden under ambient conditions over an extended period. Note that certain sealant materials such as epoxy resins may exhibit volumetric shrinkage upon curing, which may contribute to enhance mechanical compression by pulling the vertical stack 112 layers more tightly together, thereby improving the seal integrity and mechanical stability of the device.

Afterward, the entire stack may be removed from the base alignment fixture 180 and it may be transferred to a dry etching system and may be exposed to anisotropic etching using e.g. chlorine-based plasma to vertically open the inlets/outlets e.g. 150A1-150A4, 150B1-150B4 across the entire thickness of the vertical stack 112. These access channels may allow fluidic communication with each of the individual dilute, concentrate brine, and electrode rinse compartment. Finally, the soft plug, e.g. the PDMS plug, over the electrode contact regions may be manually removed to access the electrodes 140A and 140B for electrical connections. FIG. 9B is an operational schematic illustration of an electrochemical apparatus 110, in electric desalination mode, constructed as shown in FIG. 9A, illustrating fluidic and electric contacts on both sides of the electrochemical chip, in accordance with the present disclosure. Note that the general appearance of the desalination chip 200A is illustrated as an example in FIG. 9B. As shown earlier in earlier FIGS. 7A-8C, multiple configurations, sequences or arrangements may be implemented, such as electrical and fluidic connections, top sealing layers, and the packaging methods.

After completion of the assembly and sealing process, external fluidic connectors may be attached to one or more inlet or outlet vias e.g. 150A1-150A4, 150B1-150B4 to enable connection to microtubing for fluid delivery or extraction. In configurations where certain inlet/outlet vias e.g. 150A1-150A4, 150B1-150B4 are etched completely through the vertical extent of the chip, such that they are accessible from both the top and bottom surfaces, one end of the via may be selectively closed using a cap layer 196, plug, bonded sealing element or the other methods. This allows for proper fluidic isolation and ensures controlled flow paths through the intended compartments.

FIG. 9C is an operational schematic illustration of an electrochemical apparatus 110, in electric desalination ED mode using IEMs with fixed surface charges, and constructed through combined modular assembly and/or nanofabrication, in accordance with the present disclosure. FIG. 9D is an operational schematic illustration of an electrochemical apparatus 110, in electric desalination ICP mode using IEMs with fixed surface charges, and constructed through combined modular assembly and/or nanofabrication, in accordance with the present disclosure.

Note that the combined nanofabrication and modular assembly may provide significant opportunity to optimize and make the vertical stack 112 and create the electrochemical apparatus 110. In FIGS. 9A-9D a modular assembly and packaging example was shown. Multiple methods for modular assembly, and nanofabrication might get used. For packaging, multiple methods may be used such as mechanical fastening (e.g. fastening bolts and nuts), adhesive bonding (e.g. epoxy resin, polymer adhesives), thermal bonding, encapsulation using molded or printed structures or the other methods. Additionally, it may be possible to integrate gated-IEMs 120 into the modular assembly, combined nanofabrication with modular assembly or the other methods for both ED and ICP desalination, or the other applications of the electrochemical apparatus 110, such as fuel cell, acid/base generation, hydrogen generation and electrolysis, and rechargeable solid-state battery.

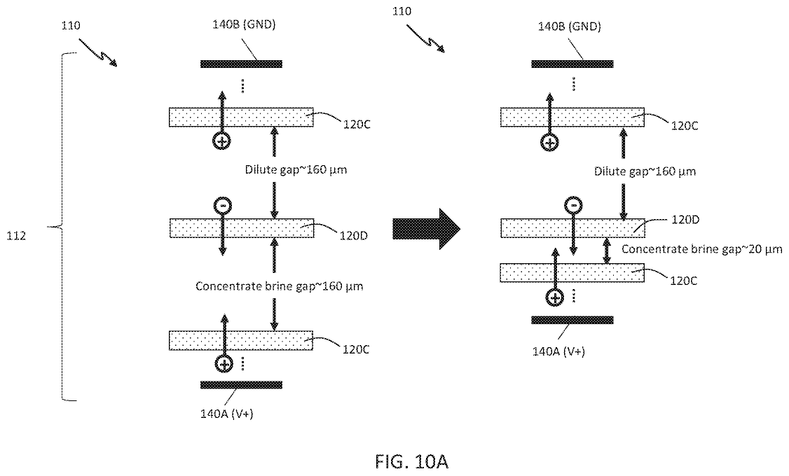

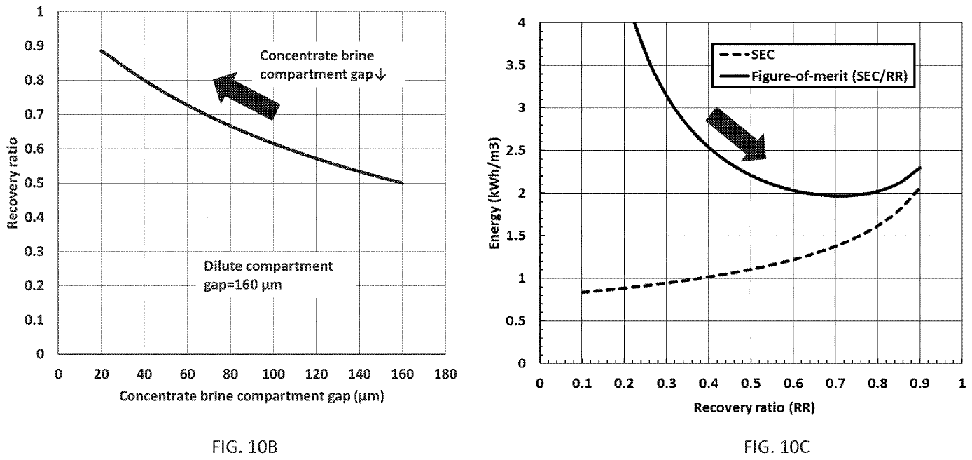

The dense vertical stack 112 for electric desalination purpose may enable the feasibility of achieving significantly higher water recovery ratios. Note that recovery ratio (RR) of a desalination system may be defined as the flow rate of the dilute outlet vs the flow rate of the input feed water. FIG. 10A is a diagrammatical illustration of an electrochemical apparatus 110 configured for electric desalination ED, showing a reduction in concentrate brine compartment gap from 160 μm (left) to 20 μm (right), as numeric value examples, while maintaining a fixed dilute compartment gap of 160 μm on both sides, in accordance with the present disclosure. Assuming that the majority of the electric potential drop may occur across the dilute compartments, it may be possible to maintain a fixed numeric value for the dilute gap e.g. at 160 μm, while reducing the gap of the concentrate brine compartments from 160 μm to e.g. 20 μm as a possible strategy to operate the device.

FIG. 10B is a graphical illustration of an electrochemical apparatus 110 in desalination ED mode, as shown in FIG. 10A, presenting recovery ratio as a function of concentrate brine compartment gap reduction, at a fixed dilute compartment gap of e.g. 160 μm, in accordance with the present disclosure. FIG. 10B shows that the estimated recovery ratio may be increasing from 50% to as high as e.g. 89%, if reducing the concentrate brine compartment gap from 160 μm to 20 μm, while maintaining a fixed dilute compartment gap of 160 μm.

Note that the minimum thermodynamic limit to desalinate sea water from e.g. 35 g/L to a final dilute concentration of e.g. 0.5 g/L may be referred to Specific Energy Consumption (SEC), typically expressed with a unit of kWh/m³. The SEC numeric value gets primarily determined by the second law of thermodynamics, specifically through the calculation of the Gibbs free energy required to separate a feed water solution into dilute and concentrate brine streams. The theoretical minimum energy is independent of the desalination method. Note that in such calculations, sodium chlorine (NaCl), or salt, gets typically used as the dominant dissolved species to represent the salinity in e.g. sea water feed, as well as in the resulting dilute and concentrate brine streams in the desalination system.

Assuming a desalination system with a feed water having a salt concentration of Cf, the system may produce a dilute stream with at salt concentration of C_{d}, and a concentrate brine stream with salt concentration of C_{b}. The desalination system may have a recovery ratio of RR, which may be defined as the ratio of dilute water output to the feed water stream. Using the second law of thermodynamics to calculate the Gibbs free energy required to separate a feed water solution into dilute and concentrate brine streams, it is possible to show that the minimum theoretical Specific Energy Consumption (SEC) to desalinate water may be calculated by EQN 3:

$$SEC = 2 RT [ \frac{{C}_{f}}{RR} ln ( \frac{{C}_{b}}{{C}_{f}} ) - {C}_{d} ln ( \frac{{C}_{b}}{{C}_{d}} ) ] \qquad ( EQN . 3 )$$

Where R is the universal gas constant and T is the absolute temperature in Kelvin unit. Considering sea water feed salinity of 35 g/L to produce a dilute stream with salt concentration of 0.5 g/L (in line with World Health Organization, WHO, guidelines for drinking water), it is possible to estimate the salt concentration in the concentrate brine stream (C_{b}) as well as the SEC at any specified RR. Note that EQN. 3 demonstrates the minimum theoretical Specific Energy Consumption (SEC), driven by the second law of thermodynamics, and the practical minimum specific energy consumption for an electric desalination may be slightly higher, possibly due to non-ideal mechanisms while operating an electric desalination system (e.g. electric, mechanical, chemical losses).

FIG. 10C is a graphical illustration of an electrochemical apparatus 110 in desalination ED mode, as shown in FIG. 10A, presenting Specific Energy Consumption (SEC) and SEC to recovery ratio (SEC/RR) as functions of RR, in accordance with the present disclosure. Note that the minimum required energy for desalination increases by increasing recovery ratio. Since desalination optimization may aim to minimize the power consumption (SEC) and increase RR, a figure-of-merit parameter of SEC/RR may be considered and its lower numeric value may be preferred. Based on FIG. 10C, the optimum region to operate the desalination device, considering the minimum of the figure-of-merit parameter of SEC/RR, may be at recovery ratio of ~70%. Note that by increasing the recovery ratio above 80%, a sharp increase in the SEC/RR may be observed. Note that at recovery ratio of around 90% or higher, the highly concentrated salt solution might approach salt saturation limit (which is ~360 g/L for NaCl). As the salt concentration may increase above certain limits, several linear or nonlinear phenomena might occur. It might include back-diffusion of water molecules from the dilute compartment to the highly concentrated brine compartment due to the elevated osmotic pressure differences, increased viscosity of the concentrate brine solution that might complicate the fluid transport, and solid salt precipitation in the concentrate brine compartments that might complicate the ion transport or obstruct the fluidic pathways.

Note that the proposed miniaturized vertical stack architectures 112 in the desalination ED mode may be expected to provide unique opportunities to tune the recovery ratio to significantly higher levels, thereby optimizing the figure-of-merit of SEC/RR. In contrast, conventional reverse osmosis (RO) systems, traditional ED stacks fabricated using traditional assembly methods (which might lack the ability to miniaturize fluidic compartments and membrane thicknesses), and traditional vertical ion concentration polarization (ICP) stacks may generally face substantial limitations in increasing recovery ratio beyond of approximately ~50% for sea water desalination. Specifically, in conventional ED stacks constructed with traditional assembly techniques, it may not be straightforward to reduce the gap of concentrate brine compartments. As a result, attempts to increase the recovery ratio in such traditional systems may often require enlarging the gap of dilute compartments, which may significantly weaken the electric field strength and it may lead to a steep increase in electric energy consumption required to perform ion transport. The proposed miniaturized stacks herein may overcome these limitations through precise architectural control of intermembrane gaps and membrane thicknesses, enabling high recovery desalination with improved energy efficiency.

FIG. 11 is an operational schematic illustration of an electrochemical apparatus 110, in a multi-stage electric desalination mode configured in series, illustrating fluidic and electric connections, in accordance with the present disclosure. Each desalination chip 200A1, 200A2 and 200A3 may be fabricated using nanofabrication, a hybrid of nanofabrication and modular assembly, or the other methods. Each chip 200A1, 200A2 and 200A3 may operate in any electric desalination method such as ED, EDI, ICP, and ICP with IER. Each chip 200A1, 200A2 and 200A3 may have various number of stacks. Each desalination chip 200A1, 200A2 and 200A3 may operate with gated-IEM 120 or IEM 120 with fixed surface charges. Each desalination chip 200A1, 200A2 and 200A3 may have its RR or salt rejection ratio (SR). Note that the SR may be defined as the percentage of salt removed from the feed water inlet to the dilute outlet.

Each desalination chip 200A1, 200A2 and 200A3 may be considered to have four electric connections to apply voltage bias schemes to e.g. electrodes 140B, 140A, and also to the gated-CEM 120C and the gated-AEM 120D layers, using e.g. electrode vias. Note that the IEM 120 layers with fixed surface charges (such as sulfonated polymers like Nafion®) do not require applying any voltage to them. In FIG. 11, three desalination chips 200A1, 200A2 and 200A3 are positioned on top of each other to minimize the lateral footprint, while other configurations may be considered. In each desalination chip 200A1, 200A2 and 200A3, the inlets/outlet 150A1-150B4, 1150B1-1150B4 and 2150B1-2150B4 vias may be assumed to be etched through the entire chip and it would be possible to access each inlet/outlet 150A1-150B4, 1150B1-1150B4, and 2150B1-2150B4 via from top and bottom side of the chip, while it is possible to use cap layers 196 to close each inlet/outlet 150A1-150B4, 1150B1-1150B4, and 2150B1-2150B4 via from one of the sides. In FIG. 11, the feed water may enter from two inlets 150A1 and 150A2 on the top side of the stage1 chip 200A1 to supply feed water to the dilute and concentrate brine compartments, respectively, within the desalination chip 200A1. The stage1 200A1 may perform partial desalination and therefore, its dilute outlet 150B1 from the bottom side of the desalination chip 200A1 may be connected to the dilute inlet of the stage2 desalination chip 200A2 for further filtration. The concentrate brine outlet 150B2 from the stage1 desalination chip 200A1 may be connected to the inlet of the concentrate brine compartments of the stage2 desalination chip 200A2. The same fluidic connection would be pursued in the stage3 chip 200A3, to receive dilute and concentrate brine streams form the 1150B1 and 1150B2 outlets of the chip 200A2, perform partial desalination inside the chip and expel a dilute stream with less salinity and a concentrate brine stream with more salinity from 2150B1 and 2150B2 outlets, respectively. In the desalination chips 200A1, 200A2 and 200A3, the internal dilute flow 152 was provided as a guideline example, while other internal dilute flow directions may be considered.

To rinse the electrodes, the buffer solution may enter from inlets 150A3 and 150A4 for top electrode 140B and bottom electrode 140A, respectively, from the top side of the stage1 desalination chip 200A1. The electrode rinse solutions may exit from bottom side outlets 150B3 and 150B4 of the stage1 desalination chip 200A1, and they may enter the top side rinsing electrode inlets of the stage2 desalination chip 200A2. They may exit from the outlets 1150B3 and 1150B4 from the bottom side of the stage2 desalination chip 200A2 and they may enter from the top side rinsing electrode inlets of the stage3 desalination chip 200A3. Finally, they may exit from rinsing electrode outlets 2150B3 and 2150B4 at the bottom of the stage3 desalination chip 200A3. Note that the fluidic connections of the electrode rinse solutions to the desalination chips 200A1, 200A2, 200A3 in FIG. 11 are provided as examples and each desalination chip 200A1, 200A2, 200A3 might have its own electrode rinse solution. In FIG. 11, it may be assumed that the top electrode 140B and the bottom electrode 140A would use separate rinse electrode solutions while both electrodes, 140B and 140A, might use the same rinse electrode solution or they may simply use feed water.

For the electric connection, each stage may deploy dependent or independent electric voltage bias schemes. In FIG. 11, for simplicity, it may be assumed that the same voltages would be applied to the electrodes 140B, 140A, and the gated-CEM 120C and gated-AEM 120D in all desalination chips 200A1, 200A2 and 200D. Therefore, electric connections 198 may be used to connect electrically chips 200A1, 200A2 and 200A3 together. In FIG. 11, it is assumed that each desalination chip 200A1, 200A2, 200A3 may include both top electrode 140A and bottom electrode 140B. Note that it may be possible to modify the desalination chips 200A1, 200A2, and 200A3 to keep only one top electrode 140A at the top of stage1 desalination chip 200A1, one electrode as the bottom electrode 140B of the stage3 desalination chip 200A3 and use buffer solution to electrically connect the bottom of stage1 desalination chip 200A1 to the top of the stage2 desalination chip 200A2, and also connect the bottom of stage2 desalination chip 200A2 to the top of the stage3 desalination chip 200A3. By implementing this method, it may be possible to mitigate the net chemical losses due to the required chemical reaction at the electrodes 140A and 140B, to perform electric charge transfer between electrode and solution phase.

In water desalination systems, e.g. sea water desalination, the discharge of concentrate brine should comply with environmental regulations. For example, some guidelines may restrict the discharged brine to no more than a 5% increase in salt concentration above natural sea water levels, although specific regulatory thresholds might vary by countries, states or regulatory institutions and might also depend on the concentrations of additional chemical constituents present in the concentrate brine stream. The electrochemical apparatus 110, which may be initially designed for electric desalination ED or EDI mode, may also be operated in an energy recovery mode, wherein the concentration gradient between feed water and concentrated brine may be used to drive ionic transport and generate electrical energy. The energy recovery configuration may be classified as a form of e.g. reverse electrodialysis (RED) or reverse electrodeionization (REDI), while the device configuration would be alternating IEMs 120 in ED or EDI mode with separate compartments for dilute and concentrate brine.

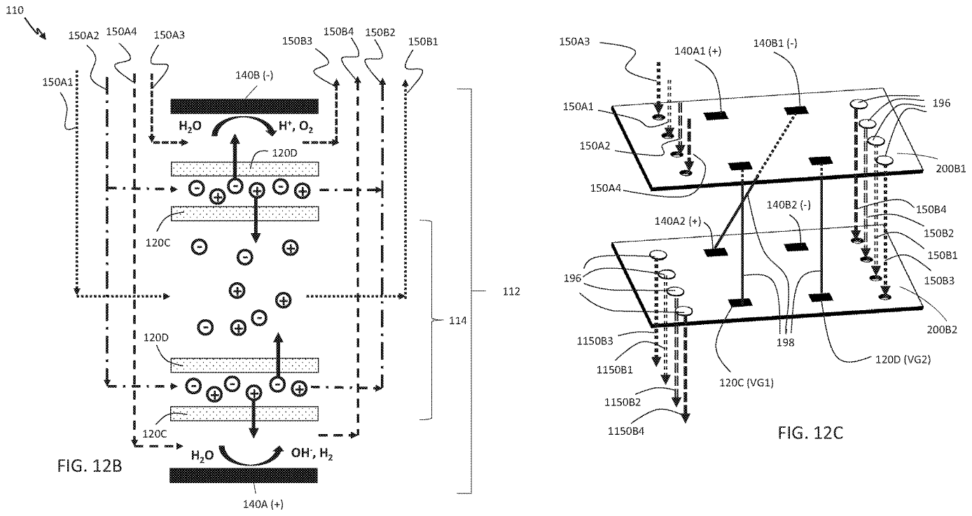

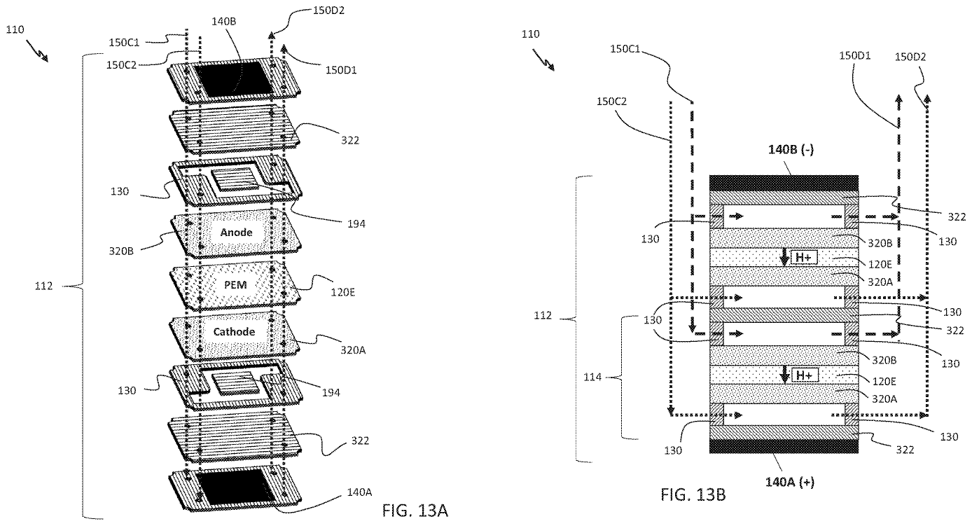

FIG. 12A is an operational schematic illustration of an electrochemical apparatus 110, in an energy recovery mode, utilizing a concentration gradient between a feed water stream and a concentrate brine stream from the prior desalination stages to generate electricity, and illustrating fluidic and electric connections, in accordance with the present disclosure. FIG. 12B is an operational schematic illustration of an electrochemical apparatus 110, in an energy recovery mode based on concentration gradient, as shown in FIG. 12A, illustrating ion transport, in accordance with the present disclosure.

As shown in FIG. 12B, the general structure of the vertical stack 112 in concentration-gradient-based energy recovery mode may follow the general structure of the vertical 112 in desalination ED or EDI mode, described earlier in FIGS. 7A-7C and is not be repeated for the sake of clarity in the disclosure. Note that in the gradient-based energy recovery mode, the dilute compartment gaps may be wider than the concentrate brine gap, to possibly accommodate large amount of feed water, since the salt concentration in the output streams of both dilute and concentrate brine compartments may not exceed e.g. 5% of the salt solution in the origin feed water for safe concentrate brine discharge to environment. The optimum compartment gap dimensions and their ratio may be determined based on e.g. the salt concentration of incoming streams (concentrate brine from the prior desalination stages, feed water) to the concentrate brine inlet of 150 as well as the maximum allowed salinity for environmental brine discharge.

The concentrate brine stream from the prior desalination stages may be directed into the concentrate brine compartment inlet 150A2 of the concentration gradient-based energy recovery chip 200B. Feed water may be directed into the dilute compartment inlet 150A1. Driven by the salinity gradient, ions may migrate from the concentrate brine compartments through the IEMs 120 into the dilute compartments, and it may establish a net electric field across the entire vertical stack 112. Electrochemical half-reactions at the electrodes 140A and 140B may sustain electric charge balance and may enable the development of an external voltage such as 140A(+) and 140B (−), may allow electrical energy to be extracted from the system. To facilitate the transfer of electric charge between the solution phase and electrodes, EQNS. 1 and 2 may be considered as half-reactions. Note that the other half-reactions may be favorable by design, considering various electrochemistry, various electrode rinse solutions or electrode materials. Note that the electrochemical half-reactions at electrodes 140A and 140B may maintain charge balance in the system and enable sustained electric current during operation of the energy recovery stack. The outlets of both dilute and concentration brine compartments 150 may produce intermediate-concentration effluent streams, thereby may reduce the overall salinity of the brine prior to discharge. The outlet streams 150, corresponding to the concentrate and dilute compartments, may be discharged directly to e.g. environment or routed for further treatment, depending on regulatory and system design requirements.

Note that it may be possible to use multiple concentration gradient-based energy recovery chips 200B, in series to dilute the concentrate brine further, or the other configurations, to meet the regulatory discharge limits or generate more electricity. FIG. 12C is an operational schematic illustration of an electrochemical apparatus 110, in an energy recovery mode based on concentration gradient, as shown in FIG. 12A, illustrating a multi-stage operation configured in series, in accordance with the present disclosure. Each concentration gradient-based energy recovery stage 200B1 and 200B2 may operate in either RED or REDI mode and may be independently configured with specific parameters, including but not limited to the number of stacks, the gap dimensions of the dilute and concentrate brine compartments, and the type of IEM (e.g. sulfonated IEM or gated-IEM). Electric connections 198 may be used to connect electrodes between multiple stages to be able to e.g. extract a high voltage from a multi-stage concentration gradient-based energy recovery architecture, while other electrical connection configurations may be used.

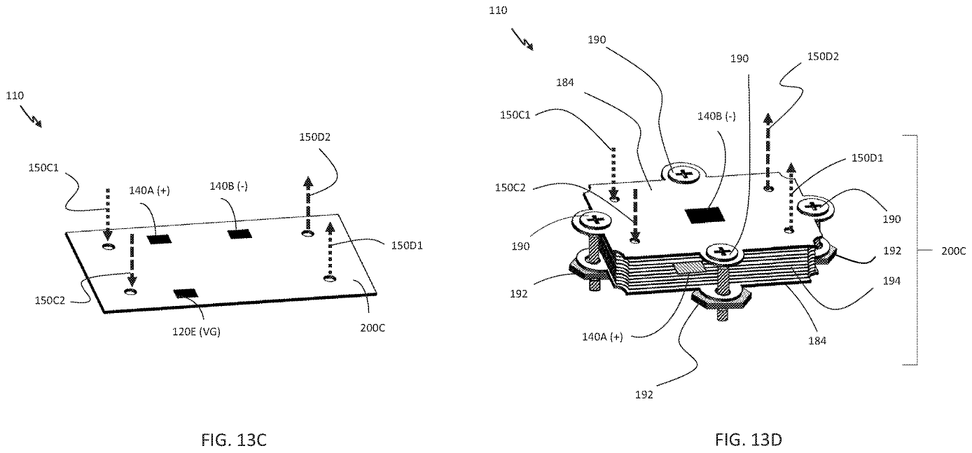

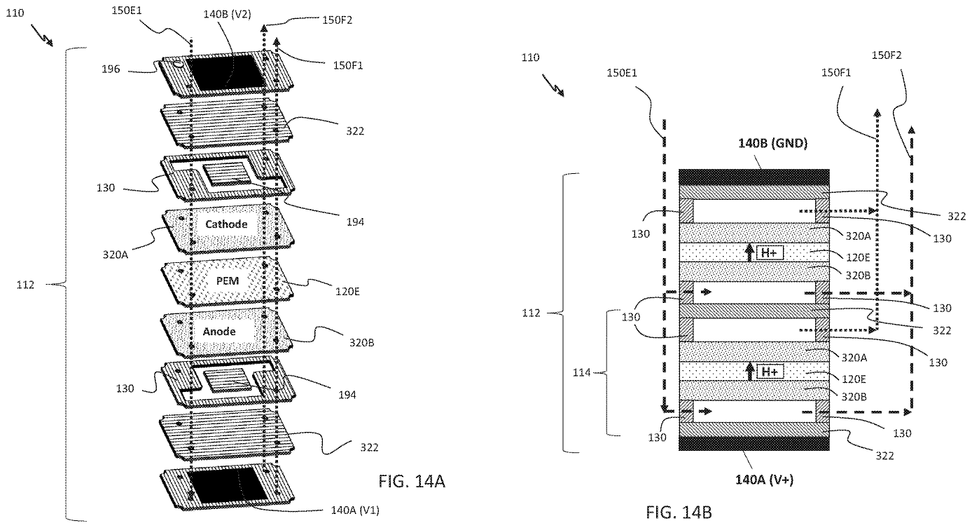

FIG. 13A is an operational schematic illustration of an electrochemical apparatus 110, in a fuel cell mode using PEMs 120E with fixed surface charges, and constructed through combined modular assembly and/or nanofabrication, in accordance with the present disclosure.

As shown, the general structure of the vertical stack 112 to operate in fuel cell mode includes at least one IEM 120 layer in substantially parallel alignment e.g. PEM 120E; locating at least one IEM 120 (e.g. PEM 120E) membrane positioned between at least two porous electrodes 320A, 320B. At least one gasket 130 is positioned between at least one porous electrode 320 layer and at least one bipolar plate 322. At least one bipolar plate 322 is positioned between at least one gasket 130 and at least one electrode 140. At least one IEM 120 e.g. PEM 120E, at least two porous electrodes 320A and 320B, at least two gaskets 130, and at least two bipolar plates 322 are positioned between at least two electrodes 140A, 140B. In addition, the vertical stack 112 may include spacers 194. The IEM membrane 120 for the fuel cell may be a PEM 120E such as Nafion®, although other types of IEMs may also be considered. The bipolar plates 322 may serve to confine the porous cathode 320A compartments and porous anode 320B compartments, while providing electrically conductive paths for electrons between adjacent repeating fuel cell units 114 within a vertical stack 112 or between the adjacent repeating fuel cell units 114 and the edge electrodes 140A and 140B. In fuel cell mode, the gasket layers 130 should be also electrically conductive for electrons and they may be composed of carbon-loaded PTFE or the other electrically conductive materials. In comparison to the traditional fuel cell systems, the dense vertical stack 112 may include ultra-thin IEM 120, which may result a significant reduction of internal electrical resistance of the fuel cell. In addition, the thickness of other components such as porous electrode layers 320 and gaskets 130 might also get reduced, further contributing to the overall electrical resistance reduction of the dense vertical stack 112. Consequently, it may be possible to achieve substantially higher operating electric currents from a dense vertical stack of fuel cell architecture. Note that FIG. 13A was provided as an example of a fuel cell architecture, and the vertical stack 112 may be fabricated using nanofabrication, modular assembly, a combined nanofabrication/modular assembly process, or other suitable methods, as previously described in the prior sections.

The porous electrode layers 320A and 320B may include graphite sheets including porous structures or array of holes and they may be formed by lithography and dry etching through the electrode layers before stacking them, or by the other methods. Alternatively, scaffold layers of thin films containing porous structures may be considered as the base layers as well. A thin conformal catalyst layer, such as a few nanometers of platinum, may be deposited over the electrode surfaces and the internal surfaces of the porous structures, particularly for the anode 320B. The electrode sheets may be patterned using laser cutting or the other methods.

In FIG. 13A, the IEM membrane 120 may be cut either individually or in batches, for example, using a laser cutting tool. Electrically conductive and gas-impermeable layers (e.g. carbon-loaded PTFE) may be used to form gaskets 130 to define the compartments for porous anodes 320B and porous cathodes 320A. Additionally, spacer layers 194 (e.g., fabricated from PTFE sheets) may be used within the gaskets 130. For assembly of the complete vertical stack 112, a similar method in FIGS. 9A-9B may be used. The other methods may be employed as well.

FIG. 13B is an operational schematic illustration of an electrochemical apparatus 110, in a fuel cell mode using PEMs 120E with fixed surface charges, as shown in FIG. 13A, illustrating ion transport, in accordance with the present disclosure. The vertical stack 112 may include several repeating units 114, in fuel cell operation mode. Each repeating unit 114, for fuel cell operation, may include a bipolar layer 322, a gasket 130, a porous cathode 320A, PEM 120E, a porous anode 320B, a gasket 130, and a bipolar plate 322. The vertical stack may include any numbers of repeating units 114. Hydrogen gas (H₂) and oxygen gas (O₂) (or air as an alternative) may be injected through separate inlets 150C1 and 150C2, respectively, and they may be directed into the porous anode 320B and porous cathode 320A compartments, respectively. The gas molecules might diffuse through the porous structures of the porous electrodes 320A and 320B. At the porous anode 320B, H₂ gas may undergoes oxidation, producing protons (H+ ions), as described in EQN. 4. The protons may migrate across the PEM membrane 120E toward the porous cathode 320A direction, where they may recombine with oxygen molecules at the porous cathode 320A and PEM 120E interface, to form water molecules (H₂O), as described by EQN. 5. The excess H₂ gas may be directed to an outlet 150D1, while the excess O₂ gas and the produced water may be directed to a separate outlet 150D2. If desired, the excess gases may be processed in further subsequent fuel cell stages for additional energy recovery.

H₂→2H⁺+2e⁻ (EQN. 4)

½O₂+2H⁺+2e⁻→H₂O (EQN. 5)

Based on the half-reaction, described in EQN. 4, during the fuel cell operation, electrons may be injected into the porous anode layers 320B. Based on the half-reaction, descried in EQN. 4, electrons may be extracted from the porous cathode layers 320A. As a result, an electric potential may be established between the porous cathode layer 320A and porous anode layer 320B in each repeating unit 114 of the fuel cell, and throughout the entire vertical stack 112. Note that the PEM layers 120E may conduct electric charges exclusively by protons but not electrons. By operating a dense vertical stack 112 in fuel cell mode, it may be possible to obtain a large net voltage between electrodes 140A(+) and 140B(−), located at the opposite sides of the vertical stack 112, which may be the cumulative electric potentials generated from each repeating unit 114 of fuel cell. Consequently, the dense vertical stack 112 architecture, or multiple stacks instances thereof, may provide sufficient output electric power to operate devices requiring large amounts of energy, such as fuel cell vehicles.

FIG. 13C is an operational schematic illustration of an electrochemical apparatus 110, in a fuel cell mode using gated-PEMs 120E, illustrating fluidic and electric connections, in accordance with the present disclosure. FIG. 13D is an operational schematic illustration of an electrochemical apparatus 110, in a fuel cell mode using PEMs 120E with fixed surface charges, illustrating fluidic and electric connections, and constructed through combined modular assembly and/or nanofabrication in accordance with the present disclosure. Note that in case of using gated-PEM 120E, a voltage of e.g. VG might need to be applied to each individual gated-PEM 120E to tune the surface charges in the PEM layer 120E. Note that in case of using gated-PEM 120E, multiple gate voltages may be applied to individual or groups of PEM 120E layers. Note that in case of using PEM membranes 120E with fixed surface charges (such as Nafion® or Sustainion®), it is not required to apply a voltage to the PEM layers 120E. Note that in FIG. 13D, the fuel cell may be also constructed using gated-PEM 120E, and FIG. 13D was provided as an example.

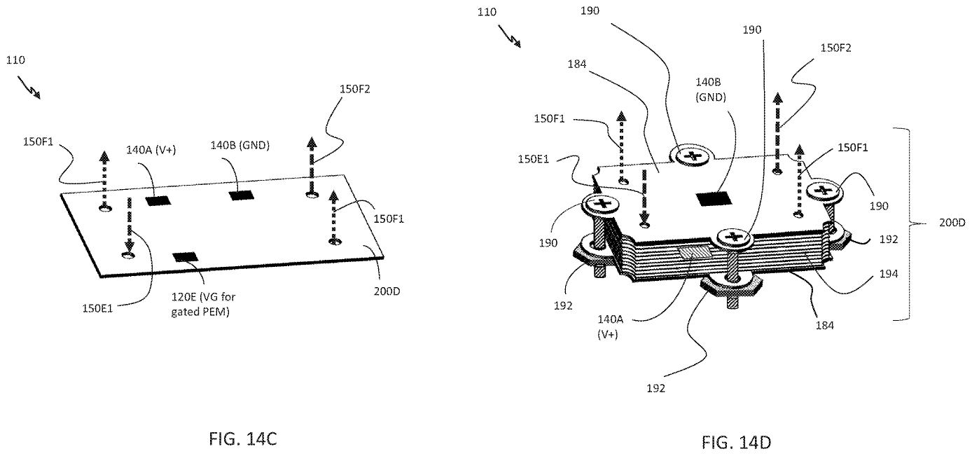

FIGS. 14A-14D are diagrammatical illustrations of an electrochemical apparatus 110 for hydrogen generation and electrolysis, in accordance with the present disclosure. As shown, the general structure of the vertical stack 112 to operate in hydrogen generation and electrolysis mode includes at least one IEM 120 layer in substantially parallel alignment e.g. PEM 120E; locating at least one IEM 120 e.g. PEM 120E membrane positioned between at least two porous electrodes 320A, 320B. At least one gasket 130 is positioned between at least one porous electrode 320A layer and at least one bipolar plate 322. At least one gasket 130 is positioned between at least one porous electrode 320B layer and at least one bipolar plate 322. At least one bipolar plate 322 is positioned between at least one gasket 130 and at least one electrode 140A. At least one bipolar plate 322 is positioned between at least one gasket 130 and at least one electrode 140B. At least one IEM 120 e.g. PEM 120E, at least two porous electrodes, at least two gaskets 130, and at least two bipolar plates 322 are positioned between at least two electrodes 140A, 140B.

In addition, the vertical stack 112 may include spacers 194. The IEM membrane 120 for electrolysis and hydrogen generation may be a PEM 120E such as Nafion®, although other types of IEMs may also be considered. In comparison to the traditional prior arts in electrolysis and hydrogen generation, the dense vertical stack 112 may include ultra-thin IEM 120 layer, which may enhance the ion transport due to the elevated electric field as well as ionic electrical resistance reduction due to shorter ion transport path. In addition, the elevated electric field across the ultra-thin IEM 120 layer may assist in weakening the hydrogen bonds between water molecules and/or the O—H bonds within water molecules, thereby may reduce the activation energy required for water splitting half-reactions to generate H₂ and O₂ gases. It may contribute to lower overpotentials or faster electrochemical kinetics comparted to the conventional electrolysis systems.

The vertical stack 112 for electrolysis may be fabricated using nanofabrication, modular assembly, a combined nanofabrication/modular assembly process, or other suitable manufacturing methods. The fabrication approach may follow the methods described previously for the fuel cell application, with appropriate modifications for electrolysis operation. The vertical stack 112 for electrolysis may comprise alternating porous cathode 320A and porous anode 320A, featuring pores to facilitate ion transport and gas bubble migration, interleaved with PEM 120E membranes, bipolar layers 322, gaskets 130, and/or spacers 194. The porous electrodes 320A and 320B in electrodialysis and hydrogen generation mode may follow the same designs that were described in the fuel cell operation mode. Note that in the hydrogen generation and electrolysis mode, the water flow may be directed to the anode compartments using inlet 150E1. The excess inlets with direct access to the cathode compartments may be closed using a cap layer 196. Hydrogen gas gets expelled from outlet 150F1 in direct fluidic connection with the cathode compartments. Oxygen gas and excess water may be expelled through outlet 150F2 in direct fluidic connection with the anode compartments.

FIG. 14A is an operational schematic illustration of an electrochemical apparatus 110, in a hydrogen generation and electrolysis mode using PEMs 120E with fixed surface charges, and constructed through combined modular assembly and/or nanofabrication, in accordance with the present disclosure. The water flow may be directed into the anode compartments using inlet 150E1. Oxygen gas and excess water may be expelled through outlet 150F2 in direct fluidic connection with the anode compartments. Hydrogen gas may be expelled from outlet 150F1 in direct fluidic connection with the cathode compartments. The inlet with direct access to the cathode compartments may be closed with a cap layer 196, or it may be used as another outlet 150F1 to expel hydrogen gas.

FIG. 14B is an operational schematic illustration of an electrochemical apparatus 110, in a hydrogen generation and electrolysis mode using PEMs 120E with fixed surface charges, as shown in FIG. 14A, illustrating ion transport, in accordance with the present disclosure. The vertical stack 112 may include several repeating units 114, in hydrogen generation and electrolysis mode. Each repeating unit 114, for hydrogen generation and electrolysis operation, may include a bipolar layer 322, a gasket 130, a porous cathode 320A, a PEM 120E, a porous anode 320B, a gasket 130, and a bipolar layer 322. A bias voltage scheme of e.g. V+ may be applied to the 140A electrode and GND may be applied to the 140B electrode. Since the porous cathode 320A, porous anode 320B, gaskets 130 and bipolar layer 322 may be electrically conductive to electrons, the applied electric potential difference between electrodes 140A and 140B might get distributed across the PEM 120E layers within the vertical stack 112. Water molecules directed into the porous anode 320B compartments via an inlet 150E1 may undergo the oxidation half-reaction, as described by EQN. 6, and it may inject electrons into the porous anode 320B layers and may generate oxygen gas (O₂), protons (H+ ions). The protons may migrate through the PEM layers 120E toward the porous cathodes 320A, where they may recombine with electrons at the PEM 120E and porous cathode 320 interface, generating hydrogen gas (H₂), according to EQN. 7.

H₂O→½O₂+2H⁺+2e⁻ (EQN. 6)

2H⁺+2e⁻→H₂ (EQN. 7)

FIG. 14C is an operational schematic illustration of an electrochemical apparatus 110, in a hydrogen generation and electrolysis mode using gated-PEMs 120E, illustrating fluidic and electric connections, in accordance with the present disclosure. FIG. 14D is an operational schematic illustration of an electrochemical apparatus 110, in a hydrogen generation and electrolysis using PEMs 120E with fixed surface charges, illustrating fluidic and electric connections, and constructed through combined modular assembly and/or nanofabrication in accordance with the present disclosure. Note that in case of using gated-PEM 120E, a voltage of e.g. VG may be applied to each individual gated-PEM 120E to tune the surface charges in the PEM layer 120E. Note that in case of using gated-PEM 120E, multiple gate voltages may be applied to individual or groups of PEM 120E layers. Note that in case of using PEM membranes 120E with fixed surface charges (such as Nafion® or Sustainion®), it is not required to apply a voltage to the PEM layers 120E. Note that the electrochemical apparatus 110, in hydrogen generation and electrolysis mode may generate hydrogen gas and oxygen gas, if using dilute water.

The electrochemical apparatus 110 may be used to generate other types of chemicals in the electrolysis mode, such as chlorine, based on e.g. half-reaction described in EQN. 8, which might serve disinfection purposes in e.g. pre-treatment or post-treatment stages of desalination. Other ionic aqueous or non-aqueous solutions may be employed to produce various fluidic chemicals using electrolysis. Note that to accommodate generation of chemicals other than hydrogen and oxygen gas using electrolysis, the apparatus 110 might require architectural modifications, including but not limited to electrode design changes and fluidic path modifications to account e.g. chemical resistance to both the incoming chemicals or the outgoing products.

2Cl⁻→Cl₂+2e⁻ (EQN. 8)

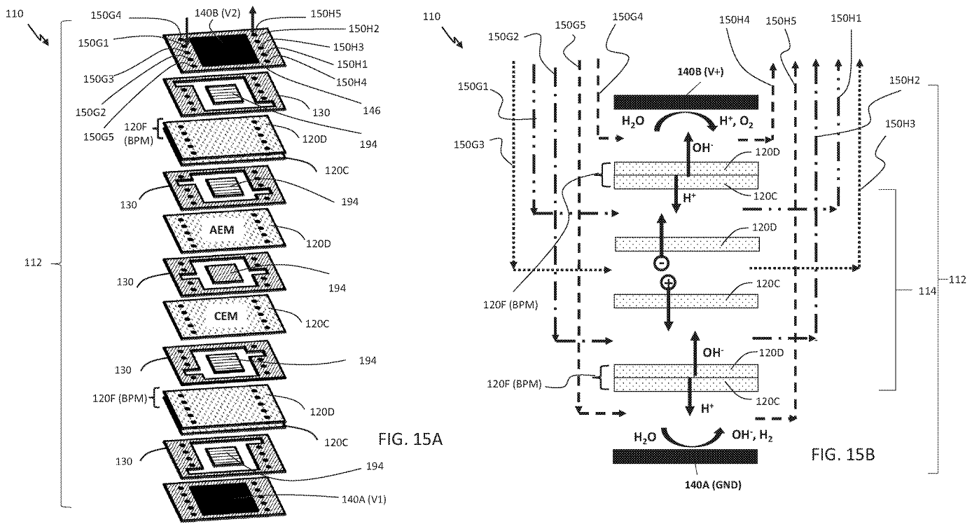

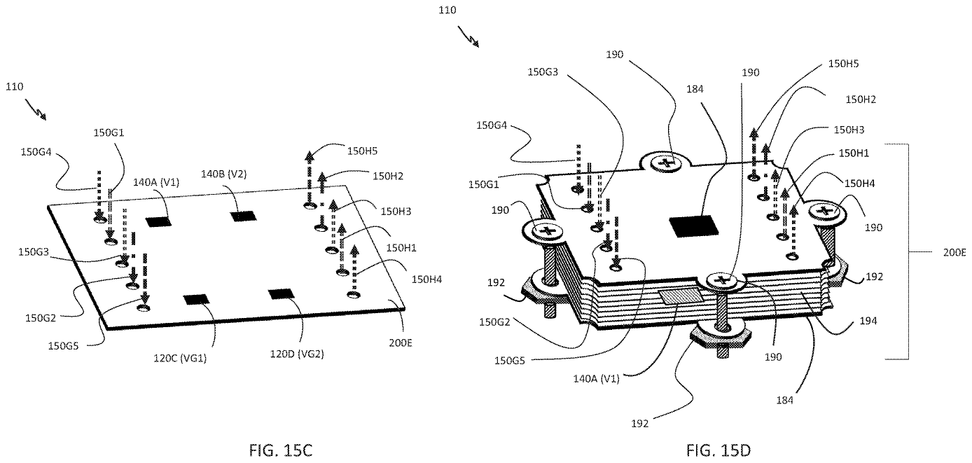

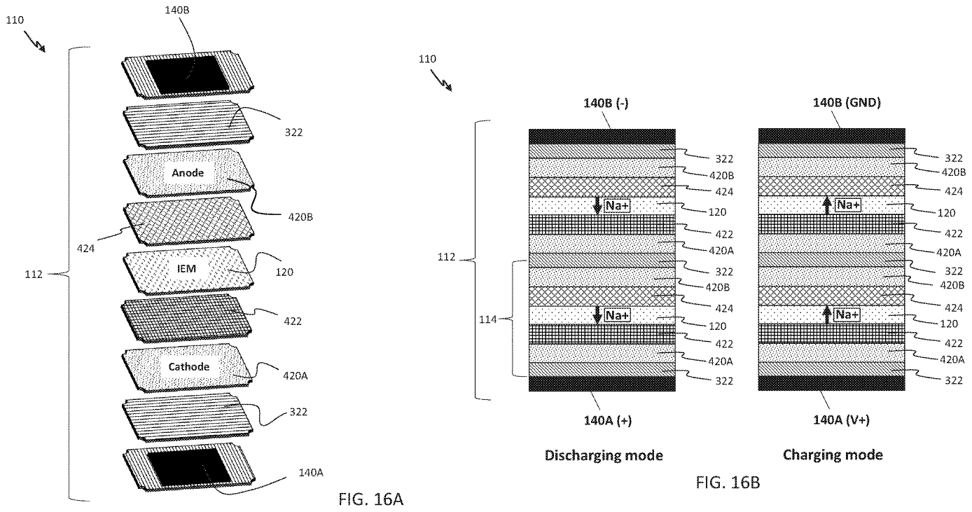

FIGS. 15A-15D illustrate example architectures of an electrochemical apparatus 110 configured to operate in acid/base generation mode, in accordance with the present disclosure. As shown, the general structure of the vertical stack 112 includes the at least two IEMs 120 positioned in substantially parallel alignment, e.g., CEM 120C, AEM 120D, along with any additional IEMs 120 which may be included. At least one gasket 130 is positioned between the at least two IEMs 120. At least one IEM 120 is placed in bipolar IEM (or BPM) 120F configuration. The at least three IEMs 120, and the at least two gaskets 130 are positioned between at least two electrodes 140A, 140B.

In comparison to the traditional prior arts in acid/base generation, the dense vertical stack 112 may incorporate ultra-thin fluidic compartments, particularly between the IEM 120 membranes. This architectural refinement may enhance ion transport in the vertical stack 112, under elevated electric field. In addition, the reduction of the thickness of fluidic compartments and IEM 120 membranes may reduce the ionic electrical resistance along the ion transport path and therefore, it may minimize overall electric energy consumption. Furthermore, the elevated electric field across the bipolar (BPM) 120F membranes may also facilitate more efficient water splitting into H+ and OH, potentially enabling generation of acid and base at reduced energy requirement.

FIG. 15A is an operational schematic illustration of an electrochemical apparatus 110, in an acid/base generation mode using IEMs 120 with fixed surface charges, and constructed through combined modular assembly and/or nanofabrication, in accordance with the present disclosure. To enable such operation, the vertical stack 112 may comprise CEM 120C layers, AEM 120D layers, bipolar IEM (or BPM) 120F layers, electrodes 140A and 140B, and gaskets 130. The BPM 120F layer may include a CEM 120C layer and an AEM 120D layer positioned adjacent to one another with minimal or no gap in between them. For acid/base generation, the vertical stack 112 may require multiple inlets. The inlet 150G1 and 150G2 may be used to introduce e.g. dilute water to acid and base compartments, respectively. The inlet 150G3 may be used to introduce saline water to be able to supply sufficient cations and anions. For 150G1-150G3, various feed water streams might get used e.g. brackish water, sea water, NaCl, KCl or other ionic solutions or compositions. The inlets 150G4 and 150G5 may be used to introduce electrode rinse solutions to electrode 140A and 140B, respectively. The acid and base streams may be expelled via 150H1 and 150H2 outlets, respectively. The dilute stream may be expelled via 150H3 outlet. The electrode rinse solutions may be expelled via 150H4 and 150H5 outlets, from electrode 140B and 140A electrodes, respectively. Note that due to the requirement for e.g. five separate outlet streams, five distinct gaskets 130 may be used to define and route the respective flow paths.

FIG. 15B is an operational schematic illustration of an electrochemical apparatus 110, in an acid/base generation mode using IEMs 120 with fixed surface charges, as shown in FIG. 15A, illustrating ion transport, in accordance with the present disclosure. The vertical stack 112 may include several repeating units 114, in acid/base generation mode. A repeating unit 114 for acid/base generation in the vertical stack 112 may include a BPM 120F layer, a CEM 120C layer, an AEM 120E layer with three compartments positioned between these IEM 120 layers (base compartment, dilute compartment, acid compartment). At least two electrodes of 140A and 140B are positioned at both sides of the vertical stack 112 and they are electrically biased, such as GND and V+, respectively. The acid and base compartments may be positioned adjacent to the BPM 120F layers. Dilute water may be injected from inlets 150G1 and 150G2 to the acid and base compartments, respectively. An ionic solution such as sea water may be injected to the dilute compartment via inlet 150G3, which may be located between the CEM 120C and AEM 120E membranes, to supply cations, e.g. Na⁺, and anions, e.g. Cl—. Under the applied external electric field, water splitting into H⁺ and OH⁻ may occur within the BPM 120F layers, and it may result injection of H⁺ ions into the acid compartments and OH-ions into the base compartments. Concurrently, the cations and anions from the ionic solution (such as Na⁺ and Cl⁻) in the dilute compartment may migrate across the CEM 120C and AEM 120E, respectively, completing the acid (H⁺ and Cl⁻) and base (Na⁺ and OH⁻) formation within acid and base compartments, respectively. The dilute flow, acid and base flows may be expelled from outlets 150H3, 150H1 and 150H2, respectively. The electrode rinse solutions may be expelled from outlets 150H4 and 150H5, from electrodes 140B and 140A, respectively.

FIG. 15C is an operational schematic illustration of an electrochemical apparatus 110, in an acid/base generation mode with gated-IEMs 120, illustrating fluidic and electric connections, in accordance with the present disclosure. FIG. 15D is an operational schematic illustration of an electrochemical apparatus 110, in an acid/base generation mode using IEMs 120 with fixed surface charges, illustrating fluidic and electric connections, and constructed through combined modular assembly and/or nanofabrication in accordance with the present disclosure. Note that in case of using gated-CEM 120C and gated-AEM 120E, voltages of e.g. VG1 and VG2 might need to be applied to each individual gated-CEM 120C and gated-AEM 120E, respectively, to tune the surface charges in the gated-CEM 120E and gated-AEM 120E layers. Note that in case of using gated-IEM 120, multiple gate voltages may be applied to individual or groups of IEM 120 layers. Note that in case of using IEM membranes 120 with fixed surface charges (such as Nafion® or Sustainion®), it is not required to apply a voltage to the IEM layers 120. FIG. 15D illustrates an example side-view of electrochemical apparatus 110 in acid/base generation mode, fabricated using combined nanofabrication and modular assembly, in accordance with the present disclosure.

FIGS. 16A-16D are diagrammatical illustrations of an electrochemical apparatus 110 for ultra-dense solid-state rechargeable batteries, in accordance with the present disclosure. As shown, the general structure of the vertical stack 112 to operate in solid-state rechargeable battery includes at least one IEM 120 layer in substantially parallel alignment. At least one IEM 120 is positioned between at least two ion host layers 422, 424. At least one ion host layer (422, 424), is placed between at least one electrode layer (420A, 420B), and at least one bipolar plate 322. At least one IEM 120, at least two ion host layers (422, 424), at least two electrode layers (420A, 420B), and at least two bipolar plates 322 are positioned between at least two electrodes (140A, 140B).

The dense vertical stack 112 may include ultra-thin IEM 120 layer, which may result a significant reduction of internal electrical resistance of the solid-state rechargeable battery. In addition, it may enable higher operating current, faster charge rates, and higher volumetric energy density. The vertical stack architecture may also enable modular scalability, simplifies manufacturing through batch or modular assembly processes. Therefore, it may reduce overall system cost by leveraging direct vertical current pathways and minimal ion transport distance between electrodes. The vertical stack 112 may be adapted for sodium, lithium or the other batteries, depending on target applications. The vertical stack of rechargeable sodium batteries may offer low-cost and resource-abundant solutions for various applications such as stationary energy storage, grid backup systems, and portable power devices. Note that sodium is resource-abundant, in contrary to rarer minerals such as lithium, while the sodium batteries may exhibit higher overall weight than lithium, primarily due to higher atomic mass of sodium vs lithium. The vertical stack of rechargeable lithium batteries, particularly with solid-state lithium metal anodes, may have potential to enable ultra-fast charging, high energy density, and high cycle life. Therefore, it may be a strong candidate for applications such as electric vehicles, urban mobility platforms, fast-charging stations, and next-generation portable electronics. Therefore, the vertical stack platform may provide a flexible foundation for addressing both cost-driven and performance-driven rechargeable battery markets by adapting the electrolyte and electrode materials as needed.

FIG. 16A is an operational schematic illustration of an electrochemical apparatus 110, in a solid-state rechargeable battery mode using IEMs 120 with fixed surface charges, and constructed through combined modular assembly and/or nanofabrication, in accordance with the present disclosure. FIG. 16B is an operational schematic illustration of an electrochemical apparatus 110, in a solid-state rechargeable battery mode using IEM 120 with fixed surface charges, as shown in FIG. 16A, illustrating ion transport in charging and discharging modes, in accordance with the present disclosure. The vertical stack 112 may include several repeating units 114 of batteries. Each repeating unit 114 of battery may include a bipolar layer 322, a cathode layer 420A, an ion host cathode layer 422, an IEM layer 120, an ion host anode layer 424, an anode layer 420B, and an additional bipolar layer 322. The bipolar 322 layers may be electrically conductive to electrons and they may be used to electrically connect the repeating unit 114 of batteries together in series, or connect the side electrode layers 140A and 140B to the repeating unit 114 batteries. The cathode layers 420A and anode layers 420B may be from electrically conductive materials such as graphite sheets with coatings, copper foil, aluminum foil, or the other electrically conductive materials. In case of a sodium-ion rechargeable battery configuration, the ion host cathode layer 422 might comprise a sodium metal oxide layer, e.g. NaFeO₂, and the ion host anode layer 424 might comprise a sodium-intercalated carbon layer, such as NaCₓ. The IEM layer 120, also referred to a separator layer, may be composed of a sodium-conducting solid-state electrolyte, e.g. NaSICON-type ceramic (e.g. Na₁₊ₓZr₂Si_{X}P_{3-X}O₁₂), which may selectively conduct Na⁺ cations while blocking transport of electrons. In some embodiments, the IEM 120 layers may be also gated-IEM 120 and they may require external voltage bias to tune the surface potential and surface charges in the IEM membrane 120. Note that the vertical stack 112 may be modified to accommodate a variety of rechargeable battery concepts such as lithium-ion, alkaline, nickel-based, or other electrochemical battery chemistries. To fabricate such vertical stack, similar methods that are described before using nanofabrication, modular assembly, combined nanofabrication and modular assembly, or the other methods might get used.

During the discharge mode, as shown on the lefthand side of FIG. 16B, the Na⁺ ions from the ion host anode layer 424, e.g. NaCₓ, may be released by the half-reaction based on EQN. 9, injecting an electron into the anode layer 420B. The released Na⁺ ions may migrate towards the cathode layer 420A via the IEM layer 120, and they may undergo the half-reaction based on EQN. 10, consuming an electron from the cathode layer 420A and they may be intercalated into the ion host cathode layer 422 (such as sodium metal oxide materials). This ion migration and charge transfer may establish an electric potential difference between the cathode layer 420A(+) and the anode layer 420B(−).

NaCₓ→Cₓ+Na⁺+e⁻ (EQN. 9)

Na⁺+e⁻+Metal Oxide→Na-Metal Oxide (EQN. 10)

In the charging mode, as shown on the righthand side of FIG. 16B, an external voltage may be applied to the electrodes 140A and 140B, such as V+ to 140A and GND to 140B. Under the resulting external electric field and at sufficient electric potential difference between the cathode layer 420A and anode layer 420B, the half-reaction of EQN. 11 may occur, releasing Na⁺ ion from the ion host cathode layer 422. The Na⁺ ions may migrate via the IEM 120 layer, due to the external electric field, and they may undergo the half-reaction of EQN. 12, getting intercalated into the ion host anode layer 424.

Na-Metal Oxide→Na⁺+e⁻+Metal Oxide (EQN. 11)

Na⁺+e⁻+Cₓ→NaCₓ (EQN. 12)

FIG. 16C is side-view illustration of an electrochemical apparatus 110, in a solid-state rechargeable battery mode with gated-IEMs 120, illustrating electric connections, in accordance with the present disclosure. FIG. 16D is side-view illustration of an electrochemical apparatus 110, in a solid-state rechargeable battery mode using IEMs 120 with fixed surface charges, illustrating electric connections, and constructed through combined modular assembly and/or nanofabrication in accordance with the present disclosure. Note that in case of using gated-IEM 120, a voltage of e.g. VG might need to be applied to each individual gated-IEM 120 to tune the surface charges in the IEM layer 120. Note that in case of using gated-IEM 120, multiple gate voltages may be applied to individual or groups of IEM 120 layers. Note that in case of using IEM 120 membranes with fixed surface charges, it is not required to apply a voltage to the IEM 120 layers.

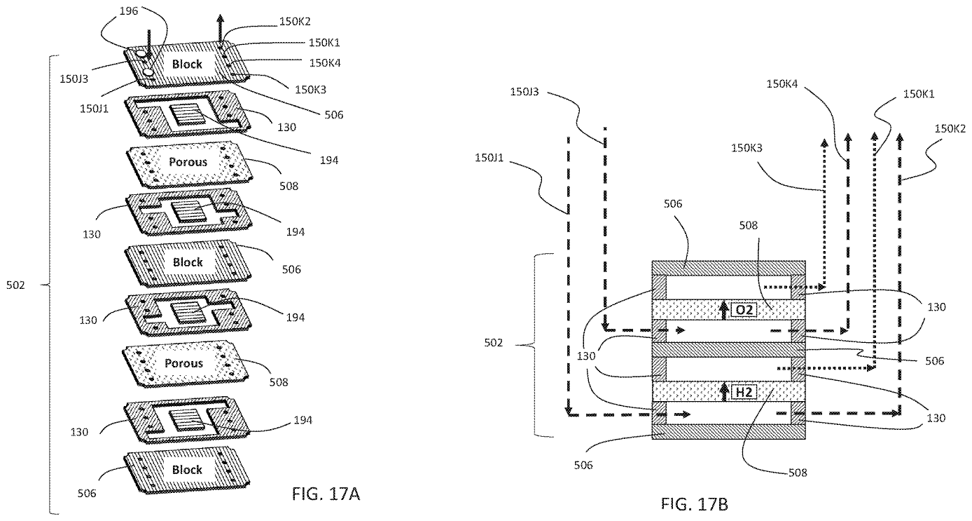

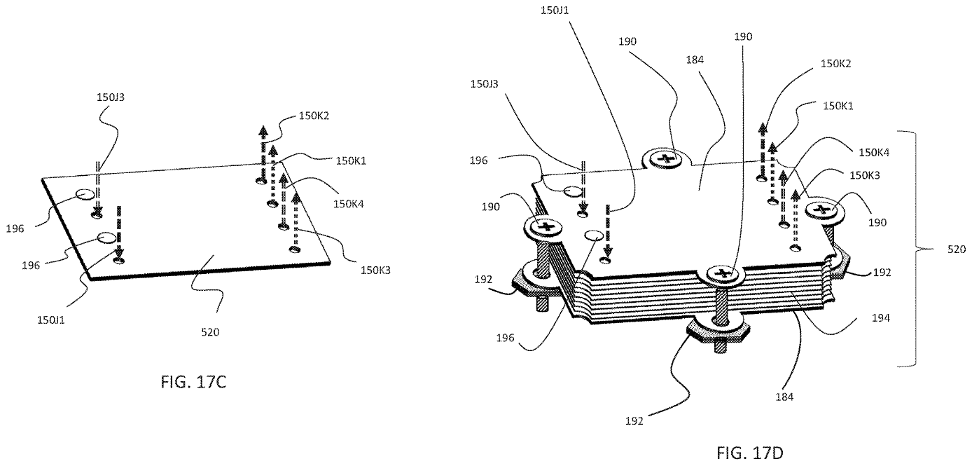

FIGS. 17A-17D are diagrammatical illustrations of a non-electrochemical vertical stack module 502 for passive separation of hydrogen and oxygen gases from the electrode rinse solutions, with no electric energy consumption, in accordance with the present disclosure. Note that such degassing chips 520 may be essential for removing gases (such as hydrogen and oxygen) generated during operation of various electrochemical components, allowing reuse of electrode rinse solutions over an extended period of time and/or harvesting hydrogen and oxygen gases for energy generation using fuel cell chips 200C or other fuel cell systems.

FIGS. 17A-17B are diagrammatical illustrations of a non-electrochemical vertical stack module 502 for separation of hydrogen and oxygen gases from the electrode rinse solutions with no electric energy consumption, in accordance with the present disclosure. The non-electrochemical vertical stack module 502 may include a blocking layer 506, which may be non-porous and it may be impermeable to both gas and liquid, and a porous hydrophobic layer 508, which may selectively allow gases to escape via its pores while expelling liquid flows. Gaskets 130 may be placed between the blocking layer 506 and the porous hydrophobic layer 508 to define the gas and the fluidic compartments, including optionally spacers 194 to define better the fluidic pathways and structural integrity. The hydrogen-rich electrode rinse solution, which was produced during the operation of an upstream electrochemical apparatus 110, might enter inlet 150J1 of the non-electrochemical vertical stack module 502 and the hydrogen gas might pass through the pores in the porous hydrophobic layer 508 and it might get expelled from outlet 150K1. The electrode rinse solution with minimal or no hydrogen gas may be expelled from outlet 150K2. The oxygen-rich electrode rinse solution, which was produced during the operation of an upstream electrochemical apparatus 110, might enter inlet 150J3 of the non-electrochemical vertical stack module 502 and the oxygen gas might pass through the pores in the porous hydrophobic layer 508 and it might get expelled from outlet 150K3. The electrode rinse solution with minimal or no oxygen gas may be expelled from outlet 150K4. Note that cap layers 196 may be used for some of the inlets to the gas compartments or they may be used as additional outlets 150K1 and 150K3 to expel gases from the gas compartments.

FIGS. 17C-17D are side-views of the non-electrochemical vertical stack module 502 for separation of hydrogen and oxygen gases from the electrode rinse solutions with no electric energy consumption, shown in FIGS. 17A-17B, in accordance with the present disclosure. The non-electrochemical vertical stack module 502 may be fabricated using nanofabrication, modular assembly, combined nanofabrication and modular assembly, or the other methods. The porous hydrophobic 508 layer might include thin PTFE layers or other hydrophobic materials with pores suitable for a selective gas molecule transport. The blocking 506 layer may be thick non-porous PTFE layers without pore, silicon or other impermeable materials that may prevent passage of both gas and liquid. Note that the non-electrochemical vertical stack module 502 may be used to separate various gases from liquids.

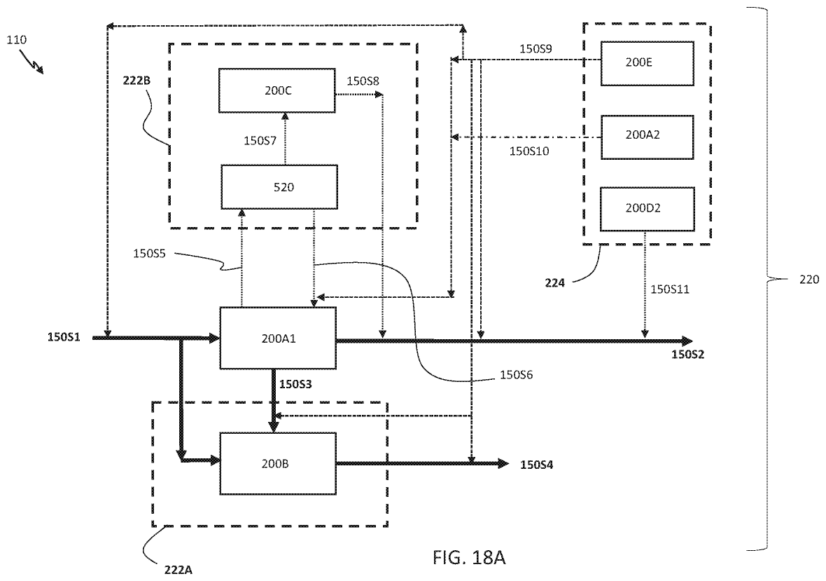

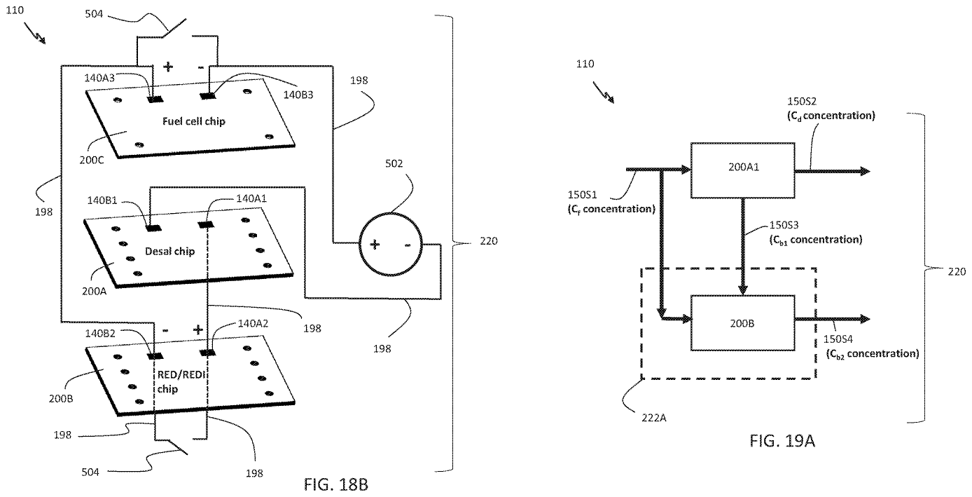

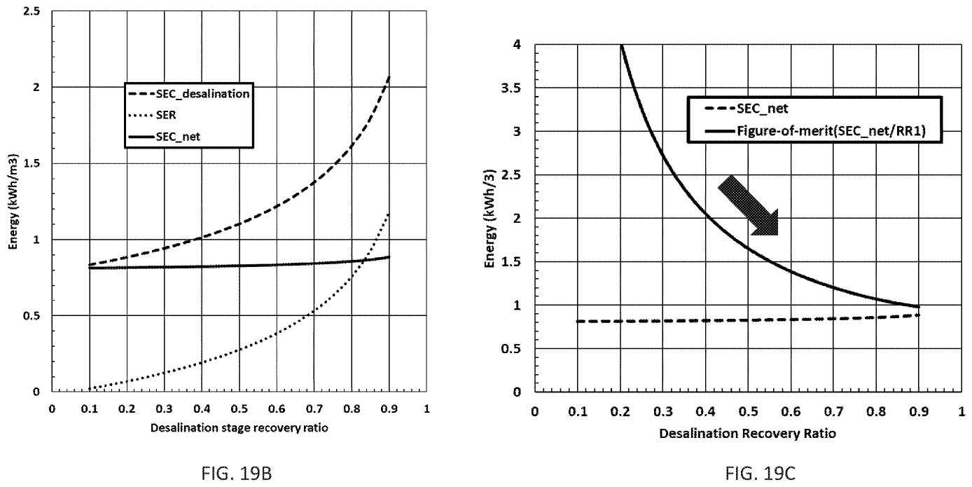

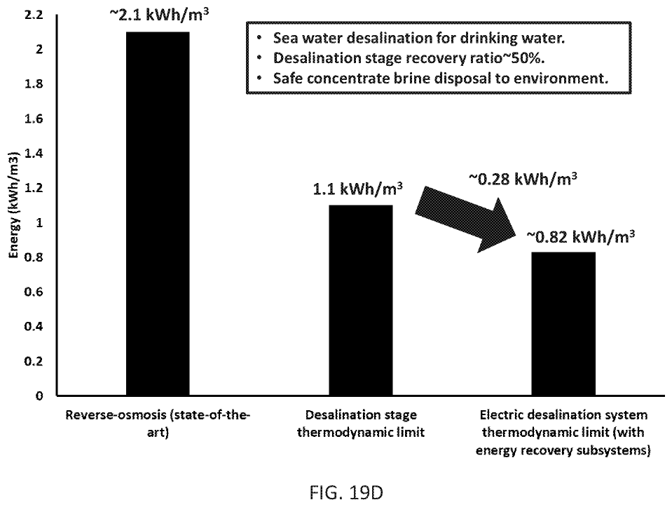

FIGS. 18A-19D describe desalination systems with vertical stacks for sub-1 kWh/m³ operation.

FIG. 18A is a diagrammatical illustration of a full-system electrochemical platform 220, for water desalination, in which one or the majority of components are based on electrochemical apparatus 110, with energy recovery subsystems 222A, 222B and a chemical dosing subsystem 224, with representative fluidic connection examples and requiring no or minimal external chemical input, in accordance with the present disclosure. The electrochemical platform 220 is designed to perform a complete water desalination, including optional energy recovery subsystems such as concentration gradient-based energy recovery subsystem 222A, and fuel cell energy recovery subsystem 222B, and a chemical dosing subsystem 224.

The chemical dosing subsystem 224 may include an acid/base generation chip 200E, a desalination chip 200A2 to provide high pure water or ultra-pure water, and a chlorine generation chip 200D2. The desalination chip 200A2, may be a single desalination or multiple desalination chips that may be operating in series to generate high-pure or ultra-pure water (such as FIG. 11). The chemical dosing subsystem 224 might receive its water input from various sources, such as dilute water stream, sea water stream or high-pure water stream from the desalination chip 200A2, depending on the system configuration and water quality requirements (such fluidic connects are not shown in FIG. 18A). The desalination chip 200A2 may be used to supply high-pure or ultra-pure water for various purposes to the electrochemical chips (such as 200A1, 200B, 200C, 200E, 200D2) and/or the other parts in the full-system electrochemical platform 220. The purified water may be used for various applications, including but not limited to electrochemical operation, dilution, liquid-based cooling or temperature stabilization. Note that for thermal management, other alternative methods may be used such as dilute water, heatsink or the other conventional thermal dissipation methods.

The fuel cell energy recovery subsystem might include a degassing chip 520 and a fuel cell chip 200C. The concentration gradient-based energy recovery subsystem might include a concentration-gradient based energy recovery chip 200B.

The inlet 150S1 supplies feed water to the desalination chip 200A1 and the concentration gradient-based energy recovery chip 200B. The feed water can be sea water, brackish or other sources of water. The feed water might undergo some prior treatments, such as micro-filtration or sediment filter, pH tuning using chemical dosing subsystem 224, other chemical tuning (external chemicals are not shown in FIG. 18A), prior getting injected to the desalination chip 200A1 and the concentration gradient-based energy recovery chip 200B. 150S3 reflects the concentrate brine outlet from the desalination chip 200A1 that may be connected to the concentration gradient-based energy recovery chip 200B. 150S4 reflects the outlet of the concentration gradient-based energy recovery chip 200B with lower salinity water which may be suitable to get discharged to e.g. sea or environment, assuming to e.g. not exceedingly more than 5% salinity of the original feed water. Note that the concentration gradient-based energy recovery chip 200B might require less treatments of the feed water prior reaching its inlet, in comparison to the desalination chip 200A1. 150S2 reflects the dilute stream outlet from the desalination chip 200A, which might undergo some treatments like pH tuning using the acid/base generation chip 200E or chlorine generation chip 200D2.

150S5 reflects the electrode rinse solution outlets of the desalination chip 200A1 may be connected to the degassing chip 520 to separate e.g. H₂ and O₂ gases from the electrode rinse streams and 150S6 reflects the degassed electrode rinse solutions from the degassing chip 520 to the electrode rinse inlets of the desalination chip 200A1. 150S7 reflects the degassing chip 520 outlets that may be contain e.g. H₂ and O₂ gases that are connected to the fuel cell chip 200C inlets to generate water and electricity. 150S8 reflects the generated water from the fuel cell chip 200C outlet that may be connected to 150S2 to join the general dilute water stream from the full-system electrochemical platform 220, or it might get disposed, or it might get used for the other purposes. In FIG. 18A, the rinse electrode solutions from the 200A1 chip were only shown to be connected to the degas chip 520 and fuel cell 200C. Such degassing and fuel cell combination might get used for the other electrochemical chips such as acid/base generation chip 200E, concentration gradient-based energy recovery chip, and the desalination chip 200A2.

The acid/base generation chip 200E in the chemical dosing subsystem 224 may be used to tune pH of various fluidic streams including but not limited to 150S1-150S8, 150S10, or any inlet or outlet of chips 200A1, 200B, 200C, 200A2, and 200D2.

A central control system might get used to monitor, control the full-system electrochemical platform 220, as well as control and connect the chemical dosing subsystem (not shown in FIG. 18A) for various fluidic connections to tune the pH of multiple fluidic streams as well as adding dilute water to tune the concentration of e.g. electrode rinse solutions in the desalination chip 200A1. Note that the electrode rinse solutions in the desalination chip 200A1 may undergo continuous electrolysis electrochemical reactions, resulting reduction of water content. Therefore, it may be required to add dilute water or high-pure water to the electrode rinse solutions from the desalination chip 200A2 in the chemical dosing subsystem 224. Note that the dilute water from the outlet 150S2 of the desalination chip 200A1 might contain a substantial amount of salt such as 0.5 g/L and it may not be suitable for electrode rinse solutions in the desalination chip 200A1, due to potential chlorine release in the electrode rinse solutions. A chlorine generation chip 200D2 may be included in the chemical dosing subsystem 224, using electrolysis to generate chlorine from either dilute water or feed water, and its chlorine product (Cl₂ gas, or a solution of NaClO/NaCl) from the outlet 150S11 of the chlorine generation chip 200D2 may be added 150S2 of the full-system electrochemical platform 220 for disinfection to supply e.g. drinking water.

Note that in FIG. 18A, the fluidic connections are provided as examples. Multiple fluidic connections may be used, such as coupling the energy recovery subsystems 222A and 222B to all other electrochemical chips (200A2, 200E, 200D2), coupling the concentration gradient energy recovery chip 200B to the energy recovery full cell 222B, and the other possible configurations. Note that the full-system electrochemical platform 220 was provided as an example here and it may contain multiple external subsystems, or parts, that can be added or modified as needed. While FIG. 18A illustrates an example configuration of the electrochemical chips (200A2, 200E, 200D2) and the energy recovery subsystems 222A and 222B, multiple configurations may be considered such as horizontal, vertical, or the other spatial arrangements. The electrochemical chips (200A2, 200E, 200D2) and the energy recovery subsystems 222A and 222B may be integrated on a common substrate by multiple methods such as fabricating them on a single substrate or a single wafer, fabricating them on multiple substrates and subsequently using some methods such as wafer bonding to integrate them on one or multiple substrates.

FIG. 18B is a diagrammatical illustration of electrical connection examples in a full-system electrochemical platform 220 for water desalination, shown in FIG. 18A, in accordance with the present disclosure. In FIG. 18B, at least one external voltage source 502 was used, which may be a DC voltage source, a coupled DC voltage source to an AC voltage, or the other configurations. The external voltage source 502 may be an electrochemical rechargeable solid-stage battery chip 200F, a solar cell, or other types of external voltage sources. The external voltage source 502 may be placed in series connection with the desalination chip 200A1, and/or at least one fuel cell chip 200C, and/or at least one concentration gradient-based energy recovery chip 200B. Note that coupling an AC voltage source to a DC voltage source to operate an electrochemical apparatus such as a desalination chip 200A1 might have some advantages such as preventing dissolved species in the fluidic components to deposit, precipitate or block the fluid streams. Bypass switches 504 may be used in parallel configurations to the fuel cell chip 200C and concentration gradient-based energy recovery chip 200B. The bypass switches 504 may be operated manually or via electric commands using e.g. a central control system unit (not shown in FIG. 18B). It might facilitate or control the operation of the desalination chip, while the energy recovery subsystems 222A, 222B might require adjustments, fine-tuning of parameters such as chemicals or chip replacement, or in the initial startup of the system which the desalination flow has not started yet to produce sufficient chemical outstream from the desalination chip 200A to the energy recovery subsystems 222A, 222B. Note that in FIG. 18B, only the desalination chip 200A was shown to be coupled to energy recovery subsystems 222A, 222B. Other components from chemical dosing subsystem 224, such as acid/base chip 200E and chlorine generation chip 200D2 may be coupled to such energy recovery subsystems 222A, 222B and degassing chips 520 as well.

For a full-system electrochemical platform 220 for desalination of water, which may include energy recovery subsystems 222A, 222B, it may be required to revisit the net Specific Energy Consumption (SECₙₑₜ) for water desalination. Note that in case of using fuel cell chips 200C to recover electrical energy from evolved H₂ and O₂ gases from the electrodes in the electrochemical chips 200A, 200B, 200E, the net minimum thermodynamic limit of chemical (Faradaic) energy to perform ion transport in the electric desalination process may approach zero, under ideal conditions. Therefore, for the SECₙₑₜ segmentation, the concentration gradient-based energy recovery subsystem 222B would be considered.

FIG. 19A is a diagrammatical illustration of fluidic connections in a full-system electrochemical platform 220 for sea water desalination, as shown in FIG. 18A, between the desalination chip 200A1 and the concentration gradient based energy recovery subsystem 222A, in accordance with the present disclosure. The feed water, might have a salt concentration of C_{f}~35 g/L (e.g. sea water). The dilute water outstream from the desalination chip 200A1 might have a salt concentration of C_{d}~0.5 g/L (in line with World Health Organization, WHO, guidelines for drinking water). The recovery ratio of the desalination chip 200A1 may be expressed as RR1, and the salt concentration of the concentrate brine outlet 150S3 of the desalination chip 200A1 may be expressed as C_{b1}. The minimum theoretical Specific Energy Consumption for desalination (SEC_{desalination}), may be calculated using the second law of thermodynamics by calculating the Gibbs free energy required to separate a feed water stream into dilute and concentrate brine streams by EQN 11:

$${SEC}_{desalination} = 2 RT [ \frac{{C}_{f}}{{RR}_{1}} ln ( \frac{{C}_{b 1}}{{C}_{f}} ) - {C}_{d} ln ( \frac{{C}_{b 1}}{{C}_{d}} ) ] \qquad ( EQN . 11 )$$

Where R is the universal gas constant and T is the absolute temperature in Kelvin unit. The concentrate brine stream from the desalination chip 200A1 with salt concentration of C_{b1} may be directed into the concentration gradient-based energy recovery chip 200B, where it might get mixed with additional feed water (e.g. C_{f}~35 g/L, if using sea water as feed water) to possibly form a concentrate brine solution suitable to discharge in environment with salt concentration of C_{b2}, which should not exceed 5% of the salinity of the original feed water. The Specific Energy Recovery (SER) may be defined by the second law of thermodynamics, by calculating the Gibbs free energy of mixing, normalized to the dilute flow outstream from the desalination chip 200A1 by EQN. 12:

$$( EQN . 12 )$$

$$SER = \{ 2 RT [ \frac{{C}_{b 2}}{{RR}_{2}} ln ( \frac{{C}_{b 1}}{{C}_{b 2}} ) - {C}_{f} ln ( \frac{{C}_{b 1}}{{C}_{d}} ) ] \} * [ \frac{\frac{1}{RR 1} - 1}{( \frac{1}{RR 2} - 1 )} ]$$

Where RR₂ is the recovery ratio of the concentration-gradient based energy recovery chip 200B. The intermediate variable parameters such as C_{b1} and RR₂ may be calculated by EQNS. 13-14, respectively, to enable calculation of SER as a function RR₁.

$${C}_{b 1} = \frac{1}{1 - RR 1} * ( {C}_{f} - {C}_{d} * {RR}_{1} ) \sim \frac{Cf}{1 - {RR}_{1}} \qquad ( EQN . 13 )$$

$${RR}_{2} = 1 - \frac{0.05 * {C}_{f}}{\frac{{C}_{b 1}}{{C}_{f}} - 1} \sim 1.05 - \frac{0.05}{RR 1} \qquad ( EQN . 14 )$$

Therefore, the net Specific Energy Consumption (SECₙₑₜ) of the full-system electrochemical platform 220 for desalination, with energy recovery subsystems (222A, 222B), may be calculated by subtracting SER from SEC_{desalination}. This value, which may depend on RR₁, may be plotted as a function of RR₁ for further analysis and energy segmentation.

FIGS. 19B-19C are graphical illustrations of energy segmentation in a full-system electrochemical platform for sea water desalination, as shown in FIG. 19A, demonstrating the feasibility of achieving sub-1.1 kWh/m³ net energy consumption through integration of energy recovery subsystems, in accordance with the present disclosure. FIG. 19B illustrates SEC for the theoretical trends for desalination stage (SEC_{desalination}), SER, and SECₙₑₜ vs the desalination stage recovery ratio, in accordance with the present disclosure. It reflects that while both the energy consumption of the desalination process (SEC_{desalination}) and the recovered energy from the concentration gradient (SER) increased with higher desalination recovery ratios, the net Specific Energy Consumption (SECₙₑₜ) remains almost constant vs the desalination recovery ratio. Specifically at desalination recovery ratio of 50%, having SEC_{desalination} of 1.1 kWh/m³, a Specific Energy Recovery (SER) of ~0.28 kWh/m³ may be possible, resulting net Specific Energy Consumption (SECₙₑₜ) of ~0.82 kWh/m³.

Note that the thermodynamic limit estimates assume ideal conditions. In practical and experimental systems, slight energy losses might occur in several stages, including, but not limited to, pumping losses, electrical resistivity losses, electrochemical overpotentials, and thermal dissipation in fuel cell operation. Note that, in the energy segmentation calculations, the additional sea water required for mixing with the concentrate brine stream expelled from the desalination chip 200A might require only minimal treatments, such as filtration or chemical dosing. Therefore, its associated energy consumption is assumed to be negligible.

Based on the FIG. 10C, a figure-of-merit for a desalination system was defined as SEC_{desalination}/RR₁, which may reflect the balance between minimizing Specific Energy Consumption for desalination (SEC_{desalination}) and maximizing the desalination recovery ratio (RR₁). FIG. 19C illustrates a revisit of this figure-of-merit parameter, by calculating SECₙₑₜ/RR₁ vs the desalination recovery ratio (RR₁). Note that under ideal thermodynamic conditions, SECₙₑₜ remains almost neutral vs the desalination stage recovery ratio. Therefore, SECₙₑₜ/RR₁ may reduce monotonically with increasing the desalination stage recovery ratio (RR₁). This behavior may highlight a major benefit of electric desalination systems that might incorporate energy recovery mechanisms and energy recovery sub-systems such as 222A and 222B, and they might operate at significantly higher recovery ratios with minimal penalty on net energy consumption.

Note that such energy saving benefits may not be achievable in traditional desalination technologies such as reverse-osmosis or thermal methods, due to possible significant challenges to recover thermal, mechanical and pumping energies, together with possible complexity and large footprint requirement to employ such recovery sub-systems. Note that concentration gradient-based energy recovery subsystems 222A may be compatible into reverse-osmosis systems, depending on the chemical profile of its concentrate brine steam and its chemical compatibility to the electrochemical components and systems.

FIG. 19D is a diagrammatical illustration of a full-system electrochemical platform 220 for sea water desalination, incorporating energy recovery subsystems (222A-222B), as described in FIG. 18A, which might operate at an overall energy consumption of substantially below 1.1 kWh/m³, such as ~0.82 kWh/m³, relative to the state-of-the-art reverse-osmosis, and the conventional thermodynamic limit for the desalination stage (1.1 kWh/m³), in accordance with the present disclosure. In FIG. 19D, sea water desalination is considered at recovery ratio of 50%, to desalinate sea water with salt concentration of 35 g/L to a dilute stream of 0.5 g/L (suitable for drinking), and discharge the concentrate brine with no more than 5% above the original sea water salinity, to comply with environmental discharge guidelines, while recover energy in the concentrate brine discharge stage, while mixing with feed sea water. The analytical calculations indicate that the theoretical minimum energy required for such an integrated electric desalination system, including energy recovery subsystems 222A and 222B, may be substantially below 1.1 kWh/m³, such as ~0.82 kWh/m³. Note that the numeric value of 0.82 kWh/m³ may be considered as a new effective thermodynamic limit for the system level electric sea desalination for drinking water purpose at desalination recovery ratio of 50%, including multiple energy recovery subsystems, while meeting the environmental concentrate brine disposal regulations.

The historically accepted thermodynamic limit for sea water desalination for drinking water is approximately 1.1 kWh/m³, at 50% recovery ratio (the desalination component only without energy recovery subsystems). The full-system electrochemical platform 220, disclosed herein based on dense vertical stacks 112, might have the potential to redefine this boundary, establishing new benchmarks for energy efficiency, not only for desalination and water treatment, but also for a broad range of electrochemical technologies, including but not limited to fuel cells, chemical production (e.g. hydrogen, acid/base), and rechargeable solid-state batteries.

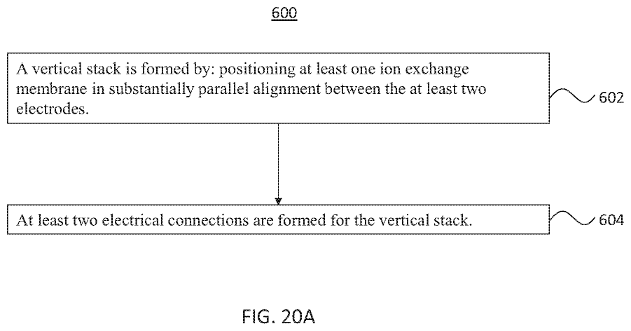

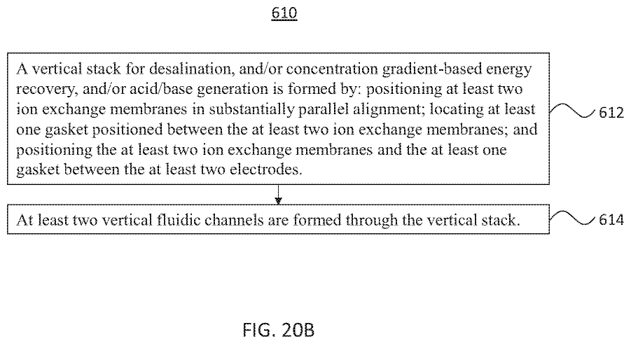

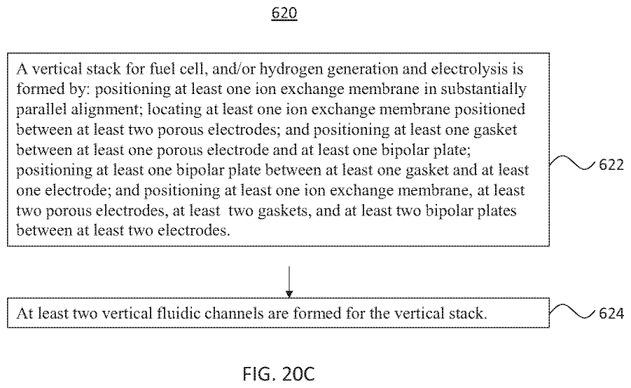

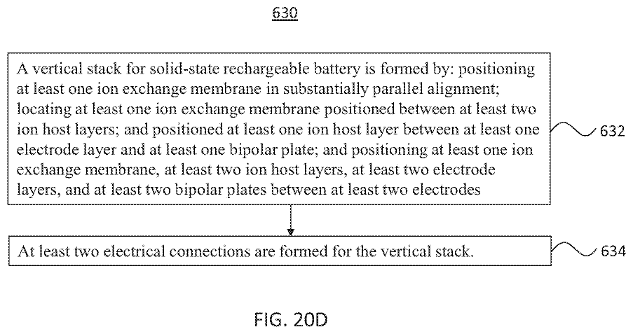

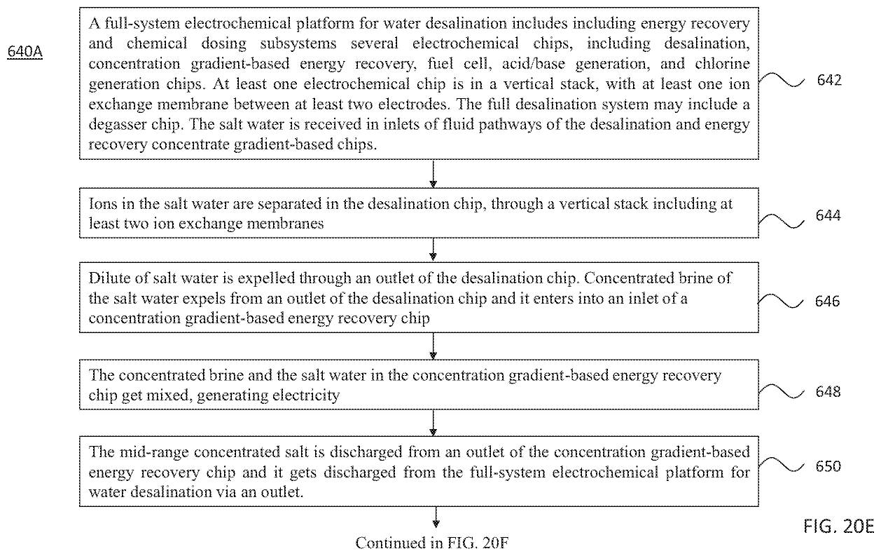

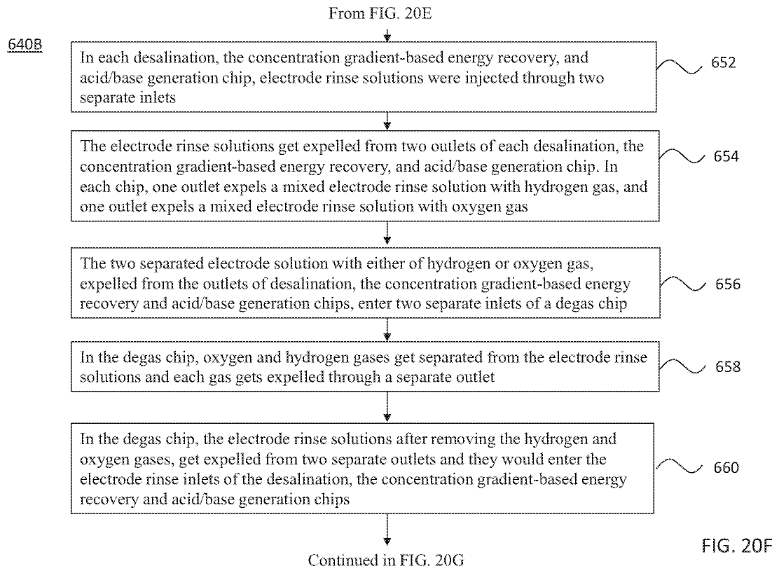

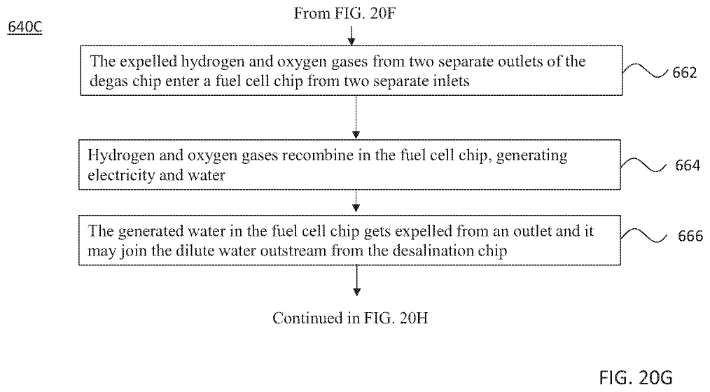

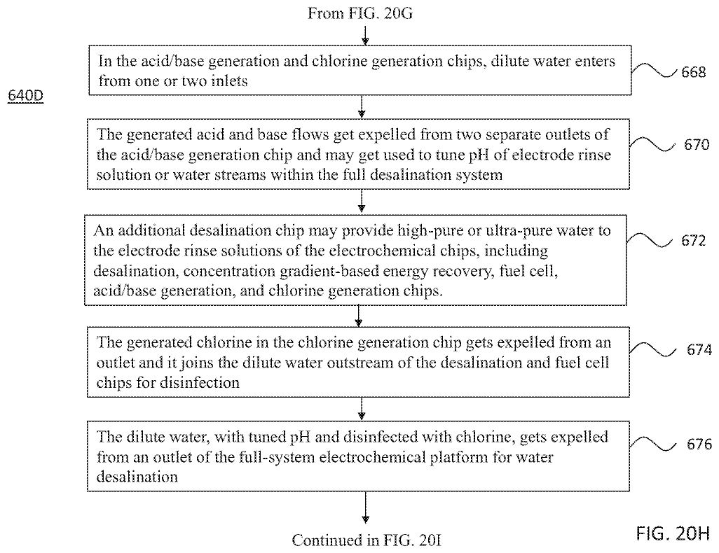

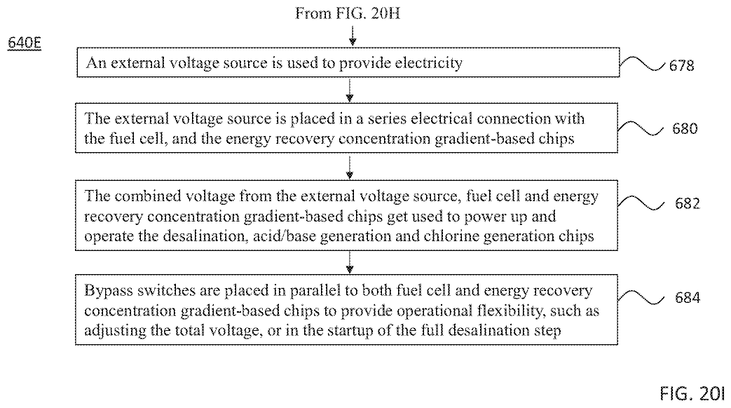

FIG. 20A is a flowchart 600 illustrating a method of manufacturing an electrochemical apparatus, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 602, a vertical stack is formed by: positioning at least one ion exchange membranes in substantially parallel alignment between the at least two electrodes. At least two electrical connections are formed for the vertical stack (block 604). Any number of additional steps, functions, processes, or variants thereof may be included in the method, including any disclosed relative to any other figure of this disclosure.

FIG. 20B is a flowchart 610 illustrating a method of manufacturing an electrochemical apparatus in desalination, and/or concentration gradient-based energy recovery, and/or acid/base generation mode(s), in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 612, a vertical stack is formed by: positioning at least two ion exchange membranes in substantially parallel alignment; locating at least one gasket positioned between the at least two ion exchange membranes; and positioning the at least two ion exchange membranes and the at least one gasket between the at least two electrodes. At least two vertical fluidic channels are formed through the vertical stack (block 614). Any number of additional steps, functions, processes, or variants thereof may be included in the method, including any disclosed relative to any other figure of this disclosure.

FIG. 20C is a flowchart 620 illustrating a method of manufacturing an electrochemical apparatus in fuel cell, and/or hydrogen generation and electrolysis mode, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 622, a vertical stack is formed by: positioning at least one ion exchange membrane in substantially parallel alignment; locating at least one ion exchange membrane positioned between at least two porous electrodes; and positioning at least one gasket between at least one porous electrode and at least one bipolar plate; positioning at least one bipolar plate between at least one gasket and at least one electrode; and positioning at least one ion exchange membrane, at least two porous electrodes, at least two gaskets, and at least two bipolar plates between at least two electrodes. At least two vertical fluidic channels are formed through the vertical stack (block 624). Any number of additional steps, functions, processes, or variants thereof may be included in the method, including any disclosed relative to any other figure of this disclosure.

FIG. 20D is a flowchart 630 illustrating a method of manufacturing an electrochemical apparatus in solid-state battery mode, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 632, a vertical stack is formed by: positioning at least one ion exchange membrane in substantially parallel alignment; locating at least one ion exchange membrane positioned between at least two ion host layers; and positioned at least one ion host layer between at least one electrode layer and at least one bipolar plate; and positioning at least one ion exchange membrane, at least two ion host layers, at least two electrode layers, and at least two bipolar plates between at least two electrodes. At least two electrical connections are formed for the vertical stack (block 634). Any number of additional steps, functions, processes, or variants thereof may be included in the method, including any disclosed relative to any other figure of this disclosure.

FIGS. 23E-23I are flowcharts 640A-640E illustrating a method of operating of full-system electrochemical platform for water desalination, including energy recovery and chemical dosing subsystems, such as several electrochemical chips, including desalination, concentration gradient-based energy recovery, fuel cell, acid/base generation, and chlorine generation chips, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 642, full-system electrochemical platform for water desalination includes including energy recovery and chemical dosing subsystems several electrochemical chips, including desalination, concentration gradient-based energy recovery, fuel cell, acid/base generation, and chlorine generation chips. At least one electrochemical chip is in a vertical stack, with at least one ion exchange membrane between at least two electrodes. The full desalination system may include a degasser chip. The salt water is received in inlets of fluid pathways of the desalination and energy recovery concentrate gradient-based chips.

As is shown by block 644, ions in the salt water are separated in the desalination chip, through a vertical stack including at least two ion exchange membranes.

As is shown by block 646, dilute of salt water is expelled through an outlet of the desalination chip. Concentrated brine of the salt water expels from an outlet of the desalination chip and it enters into an inlet of a concentration gradient-based energy recovery chip.

As is shown by block 648, the concentrated brine and the salt water in the concentration gradient-based energy recovery chip get mixed, generating electricity.

As is shown by block 650, the mid-range concentrated salt is discharged from an outlet of the concentration gradient-based energy recovery chip and it gets discharged from the full-system electrochemical platform for water desalination via an outlet.

As is shown by block 652, in each desalination, the concentration gradient-based energy recovery, and acid/base generation chip, electrode rinse solutions were injected through two separate inlets.

As is shown by block 654, the electrode rinse solutions get expelled from two outlets of each desalination, concentration gradient-based energy recovery, and acid/base generation chip. In each chip, one outlet expels a mixed electrode rinse solution with hydrogen gas, and one outlet expels a mixed electrode rinse solution with oxygen gas.

As is shown by block 656, the two separated electrode solution with either of hydrogen or oxygen gas, expelled from the outlets of desalination, the concentration gradient-based energy recovery and acid/base generation chips, enter two separate inlets of a degas chip.

As is shown by block 658, in the degas chip, oxygen and hydrogen gases get separated from the electrode rinse solutions and each gas gets expelled through a separate outlet.

As is shown by block 660, in the degas chip, the electrode rinse solutions after removing the hydrogen and oxygen gases, get expelled from two separate outlets and they would enter the electrode rinse inlets of the desalination, the concentration gradient-based energy recovery and acid/base generation chips.

As is shown by block 662, the expelled hydrogen and oxygen gases from two separate outlets of the degas chip enter a fuel cell chip from two separate inlets

As is shown by block 664, hydrogen and oxygen gases recombine in the fuel cell chip, generating electricity and water.

As is shown by block 666, the generated water in the fuel cell chip gets expelled from an outlet and it may join the dilute water outstream from the desalination chip.

As is shown by block 668, in the acid/base generation and chlorine generation chips, dilute water enters from one or two inlets.

As is shown by block 670, the generated acid and base flows get expelled from two separate outlets of the acid/base generation chip and may be used to tune pH of electrode rinse solution or water streams within the full desalination system.

As is shown by block 672, an additional desalination chip may provide high-pure or ultra-pure water to the electrode rinse solutions of the electrochemical chips, including desalination, concentration gradient-based energy recovery, fuel cell, acid/base generation, and chlorine generation chips.

As is shown by block 674, the generated chlorine in the chlorine generation chip gets expelled from an outlet and it joins the dilute water outstream of the desalination and fuel cell chips for disinfection.

As is shown by block 676, the dilute water, with tuned pH and disinfected with chlorine, gets expelled from an outlet of the full-system electrochemical platform for water desalination.

As is shown by block 678, an external voltage source is used to provide electricity.

As is shown by block 680, the external voltage source is placed in a series electrical connection with the fuel cell, and the energy recovery concentration gradient-based chips.

As is shown by block 682, the combined voltage from the external voltage source, fuel cell and energy recovery concentration gradient-based chips get used to power up and operate the desalination, acid/base generation and chlorine generation chips.

As is shown by block 684, bypass switches are placed in parallel to both fuel cell and energy recovery concentration gradient-based chips to provide operational flexibility, such as adjusting the total voltage, or in the startup of the full desalination step.

Any number of additional steps, functions, processes, or variants thereof may be included in the method, including any disclosed relative to any other figure of this disclosure.

The vertical stack described herein is designed to enhance ion transport at nanoscale. Potential applications include, but are not limited to, various water desalination (residential, commercial, brackish/sea water, remote or off-grid), zero-liquid discharge systems, preconcentration, material purification and waste management (to either concentrate or dilute a product), semiconductor/chemical/pharmaceutical/oil/food/beverage industries, healthcare (biomarker/pH/ion sensing, dialysis), electrochemical sensors, electro-organic synthesis, capacitive deionization, redox flow systems, lab-on-chip analytical devices, wearable/implantable devices (e.g. real-time health monitoring), battery and energy systems, real-time environmental monitoring, advanced fluid (flow/temperature sensing), bio sensing, chemical generation (such as acid/base, hydrogen, oxygen, chlorine), energy recovery using concentration gradient, fuel cell, and solid-state rechargeable batteries. Additional use cases might include fluidic ion logic circuits, electrically tunable pore components and systems, on-demand ionic separations, waste water valorization, and hybrid water-energy components and systems integrating desalination with electrolysis or energy storage. It can be also used for applications for desalination or material purification at the locations with very scarce power source or material (e.g. space station, moon or mars).

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of forming an electro-fluidic desalination apparatus, the method comprising:
forming a vertical stack by:
positioning at least two ion exchange membranes in substantially parallel alignment;
positioning at least one gasket positioned between the at least two ion exchange membranes; and
positioning the at least two ion exchange membranes and the at least one gasket between at least two electrodes; and
forming at least two vertical fluidic channels through the vertical stack.

2. The method of claim 1, wherein the at least two ion exchange members are suspended.

3. The method of claim 1, further comprising defining fluidic compartments within the vertical stack with the at least one gasket.

4. The method of claim 3, further comprising positioning at least one ion exchange material within the fluidic compartments.

5. The method of claim 3, wherein the fluidic compartments have a height of 5 μm or less.

6. The method of claim 2, further comprising:
forming a first sacrificial layer on a first electrode of the at least two electrodes to thereby form an electrode compartment for the first electrode;
forming the at least two ion exchange members as suspended ion exchange members with a porous, thin film layer;
forming the at least one gasket with a second sacrificial layer; and
forming a second sacrificial layer on a second electrode of the at least two electrodes.

7. The method of claim 6, further comprising forming at least one pillar in the vertical stack.

8. The method of claim 6, further comprising depositing the vertical stack on a support wafer.

9. The method of claim 1, wherein forming the at least one gasket further comprises forming the at least one gasket with a sacrificial layer by:
lithographing and local isotropic etching the sacrificial layer;
strip resistant and partial conformal etching of the sacrificial layer to create undercuts; and
conformal thin film deposition to fill etched regions in the sacrificial layer.

10. The method of claim 9, wherein the sacrificial layer further comprises a spacer layer positioned between at least two sacrificial layers, and further comprising:
isotopically etching the spacer layer; and
filling in gaps between the spacer layer and the at least two sacrificial layers with isotropic deposition.

11. A method of operating an electro-fluidic desalination apparatus, the method comprising:
providing at least one desalination chip formed in a vertical stack by:
positioning at least two ion exchange membranes in substantially parallel alignment;
positioning at least one gasket between the at least two ion exchange membranes; and
positioning the at least two ion exchange membranes and the at least one gasket between at least two electrodes;
feeding water into an inlet of the at least one desalination chip and into at least one vertical fluidic channel of the vertical stack;
applying voltage to the at least one desalination chip to at least partially desalinate the water; and
outputting the at least partially desalinated water into a dilute compartment, and outputting a brine to a concentrated brine compartment.

12. The method of claim 11, wherein applying voltage to the at least one desalination chip further comprises applying the voltage to a first electrode, a second electrode, a gated-cation exchange membrane (CEM), and a gated-anion exchange membrane (AEM).

13. The method of claim 11, further comprising rinsing the at least two electrodes by injecting a buffer solution into the inlet of the at least one desalination chip.

14. The method of claim 11, wherein the at least one desalination chip further comprises a plurality of desalination chips in fluidic communication with one another, each of the plurality of desalination chips being a desalination stage, and further comprising:
inputting the at least partially desalinated water in the dilute compartment and the brine in the concentrated brine compartment of a first desalination chip into an inlet of a second desalination chip;
applying voltage to the second desalination chip to further desalinate the at least partially desalinated water from the first desalination chip; and
outputting the at least partially desalinated water into a dilute compartment of the second desalination chip, and outputting a brine to a concentrated brine compartment of the second desalination chip.

15. The method of claim 14, wherein applying voltage to the at least one desalination chip and to the second desalination chip further comprises applying voltage to an electrical connection with both the at least one desalination chip and the second desalination chip.

16. A method of electrical energy recovery during operation of an electro-fluidic desalination apparatus, the method comprising:
providing at least one desalination chip formed in a vertical stack by:
positioning at least two ion exchange membranes in substantially parallel alignment;
positioning at least one gasket between the at least two ion exchange membranes; and
positioning the at least two ion exchange membranes and the at least one gasket between at least two electrodes;
feeding a concentrated brine stream into an inlet of a concentrated brine compartment and feeding at least partially desalinated water into an inlet of a dilute compartment, whereby ions migrate from the concentrated brine compartment through the at least two ion exchange members and into the dilute compartment thereby sustaining an electric charge at the at least two ion exchange members; and
extracting electrical energy from the electric charge at the at least two ion exchange members.

17. The method of claim 16, wherein a height dimension of the dilute compartment is larger than a height dimension of the concentrated brine compartment.

18. The method of claim 16, wherein electrochemical half-reactions sustain the electric charge at the least two ion exchange members.

19. The method of claim 16, wherein the at least one desalination chip further comprises a plurality of desalination chips in fluidic communication with one another, each of the plurality of desalination chips being a stage, wherein the plurality of desalination chips are arranged in series, whereby ions migrate from the concentrated brine compartment through the at least two ion exchange members and into the dilute compartment of each desalination chip thereby sustaining an electric charge at the at least two ion exchange members of each desalination chip, and wherein electrical energy is extracted from the electric charge at the at least two ion exchange members of each of the plurality of desalination chips.

20. The method of claim 19, wherein each stage operates in one of: a reverse electrodialysis mode or a reverse electrodeionization mode.
